(19) United States
(12) Patent Application Publication
(10) Pub. No.: US 2013/0235926 A1
(43) Pub. Date: Sep. 12, 2013

(54) Memory efficient video parameter processing

(71) Applicant: BROADCOM CORPORATION, Irvine, CA (US)

(72) Inventors: Wade K. Wan, Orange, CA (US); Peisong Chen, San Diego, CA (US)

(73) Assignee: Broadcom Corporation, Irvine, CA (US)

(21) Appl. No.: 13/781,075

(22) Filed: Feb. 28, 2013

Related U.S. Application Data
(60) Provisional application No. 61/608,056, filed on Mar. 7, 2012.

(51) Int. Cl. H04N 7/26

(52) U.S. Cl. CPC H04N 19/00212
USPC 375/240.02

(57) ABSTRACT

Memory efficient video parameter processing. A communication system including at least two respective devices, namely, a transmitter device and a receiver device, operates with significant reduction in the amount of signaling provided between those respective devices. Such devices may be transceiver devices. Considering such a transmitter device that includes an encoder, such as a video encoder, and a receiver device that includes a decoder, such as a video decoder, and output bitstream corresponding to an encoded video signal may be provided from the transmitter device and received by the receiver device. Such an output bitstream may be generated by a video encoder within the transmitter device and may subsequently undergo appropriate processing by a video decoder within the receiver device. One or more frame-based signals, corresponding respectively to the number of blocks, may be communicated as being respectively limited to at most one step of recursion among the various blocks.

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Patent Application Ser. No. 61/608,056, entitled “Memory efficient video parameter processing,” (Attorney Docket No. BP24575), filed Mar. 7, 2012, pending.

### Incorporation by Reference

The following standards/draft standards are hereby incorporated herein by reference in their entirety and are made part of the present U.S. Utility Patent Application for all purposes:

1. “High Efficiency Video Coding (HEVC) text specification draft 10 (for FDIS & Consent),” Joint Collaborative Team on Video Coding (JCT-VC) of ITU-T SG 16 WP 3 and ISO/IEC JTC 1/SC 29/WG 11, 12th Meeting: Geneva, CH, 14-23 Jan. 2013, Document: JCTVC-L1003_v11, 332 pages.

2. International Telecommunication Union, ITU-T, TELECOMMUNICATION STANDARDIZATION SECTOR OF ITU, H.264 (03/2010), SERIES H: AUDIOVISUAL AND MULTIMEDIA SYSTEMS, Infrastructure of audiovisual services—Coding of moving video, Advanced video coding for generic audiovisual services, Recommendation ITU-T H.264, also alternatively referred to as International Telecomm ISO/IEC 14496-10—MPEG-4 Part 10, AVC (Advanced Video Coding), H.264/MPEG-4 Part 10 or AVC (Advanced Video Coding), ITU H.264/MPEG4-AVC, or equivalent.

### BACKGROUND OF THE INVENTION

1. Technical Field of the Invention

The invention relates generally to digital video processing; and, more particularly, it relates to video parameter processing in accordance with such digital video processing.

2. Description of Related Art

Communication systems that operate to communicate digital media (e.g., images, video, data, etc.) have been under continual development for many years. With respect to such communication systems employing some form of video data, a number of digital images are output or displayed at some frame rate (e.g., frames per second) to effectuate a video signal suitable for output and consumption. Within many such communication systems operating using video data, there can be a trade-off between throughput (e.g., number of image frames that may be transmitted from a first location to a second location) and video and/or image quality of the signal eventually to be output or displayed. The present art does not adequately or acceptably provide a means by which video data may be transmitted from a first location to a second location in accordance with providing an adequate or acceptable video and/or image quality, ensuring a relatively low amount of overhead associated with the communications, relatively low complexity of the communication devices at respective ends of communication links, etc.

### BRIEF DESCRIPTION OF THE SEVERAL VIEWS OF THE DRAWINGS

FIG. 1 and FIG. 2 illustrate various embodiments of communication systems.

FIG. 3A illustrates an embodiment of a computer.

FIG. 3B illustrates an embodiment of a laptop computer.

FIG. 3C illustrates an embodiment of a high definition (HD) television.

FIG. 3D illustrates an embodiment of a standard definition (SD) television.

FIG. 3E illustrates an embodiment of a handheld media unit.

FIG. 3F illustrates an embodiment of a set top box (STB).

FIG. 3G illustrates an embodiment of a digital video disc (DVD) player.

FIG. 3H illustrates an embodiment of a generic digital image and/or video processing device.

FIG. 4, FIG. 5, and FIG. 6 are diagrams illustrating various embodiments of video encoding architectures.

FIG. 7 is a diagram illustrating an embodiment of intra-prediction processing.

FIG. 8 is a diagram illustrating an embodiment of inter-prediction processing.

FIG. 9 and FIG. 10 are diagrams illustrating various embodiments of video decoding architectures.

FIG. 11 illustrates an embodiment of run length coding (RLC).

FIG. 12 illustrates an embodiment of merge left.

FIG. 13 illustrates an embodiment of merge up.

FIG. 14 illustrates an embodiment of copy from entire row.

FIG. 15 illustrates an embodiment of an example of a number of largest coding units (LCUs) (alternatively, or blocks) with respective mapping there among.

FIG. 16 illustrates an embodiment of the respective mapping associated with the LCUs depicted with respect to the previous diagram, FIG. 15.

FIG. 17 illustrates an embodiment of one of the respective LCUs of previous diagrams and recursion steps associated therewith.

FIG. 18 illustrates an embodiment of selective conversion of some mappings to explicit mode information (plus run length).

FIG. 19 illustrates an embodiment of a receiver device (e.g., a decoder).

FIG. 20 illustrates an embodiment of a communication system with a transmitter (TX) and a receiver (RX).

FIG. 21 illustrates an embodiment of a method performed by one or more devices.

### DETAILED DESCRIPTION OF THE INVENTION

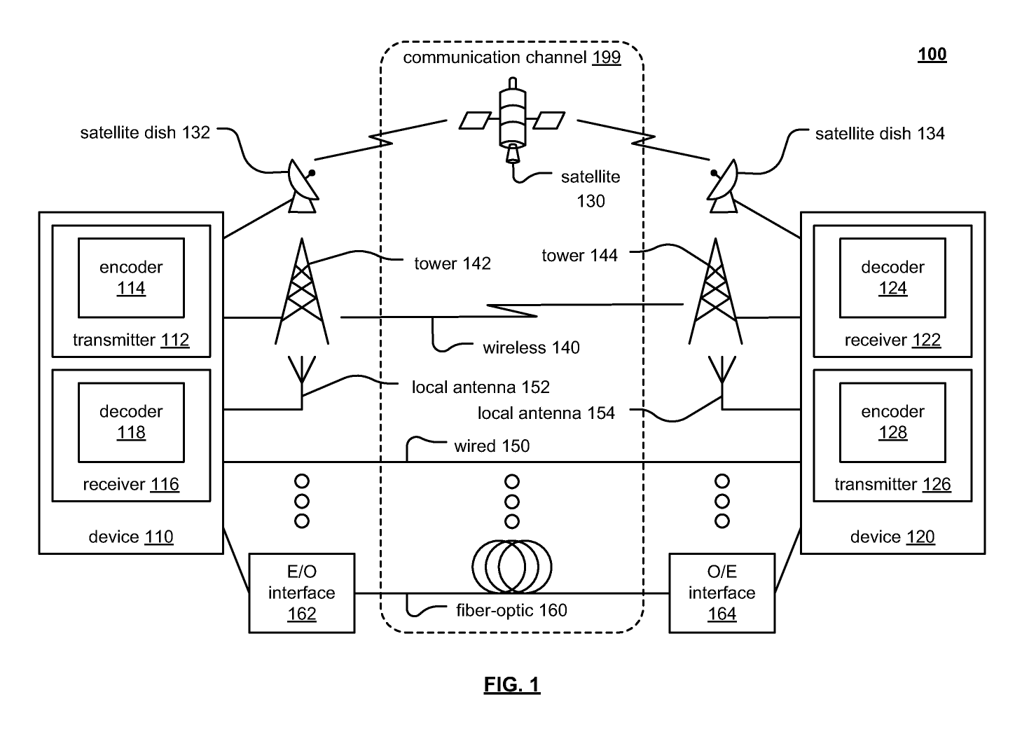

Within many devices that use digital media such as digital video, respective images thereof, being digital in nature, are represented using pixels. Within certain communication systems, digital media can be transmitted from a first location to a second location at which such media can be output or displayed. The goal of digital communications systems, including those that operate to communicate digital video, is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and/or other types of media as well.

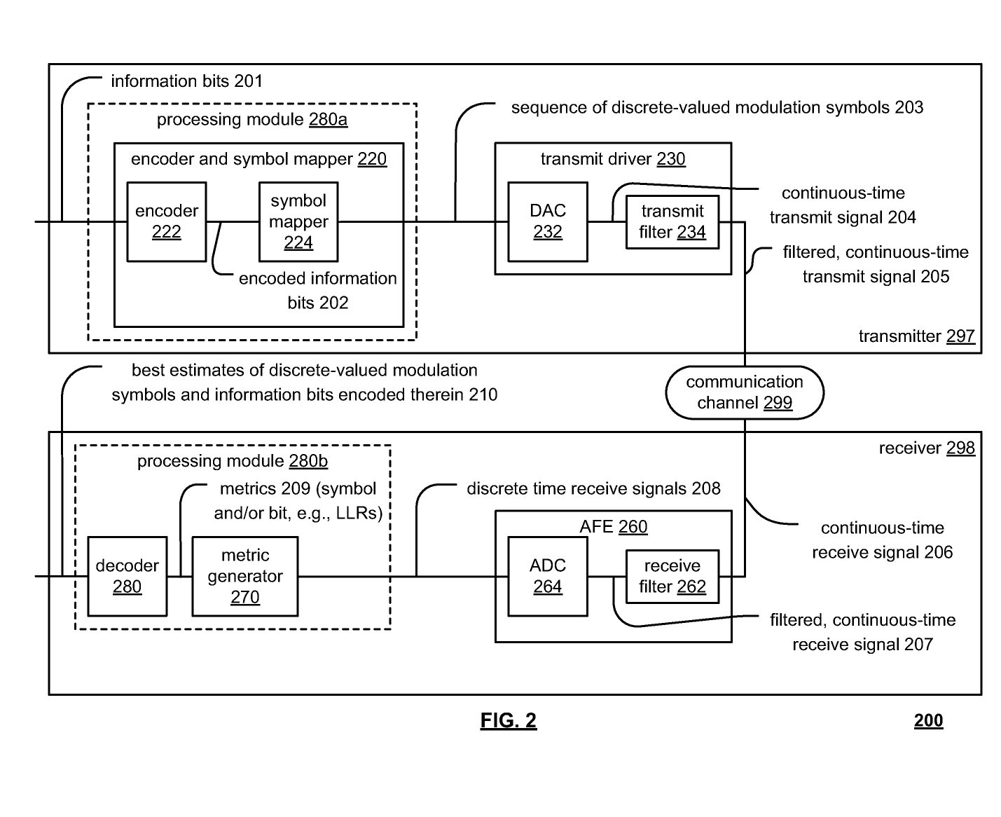

FIG. 1 and FIG. 2 are diagrams illustrate various embodiments of communication systems, 100 and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

It is noted that such communication devices 110 and/or 120 may be stationary or mobile without departing from the scope and spirit of the invention. For example, either one or both of the communication devices 110 and 120 may be implemented in a fixed location or may be a mobile communication device with capability to associate with and/or communicate with more than one network access point (e.g., different respective access points (APs) in the context of a mobile communication system including one or more wireless local area networks (WLANs), different respective satellites in the context of a mobile communication system including one or more satellite, or generally, different respective network access points in the context of a mobile communication system including one or more network access points by which communications may be effectuated with communication devices 110 and/or 120.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299).

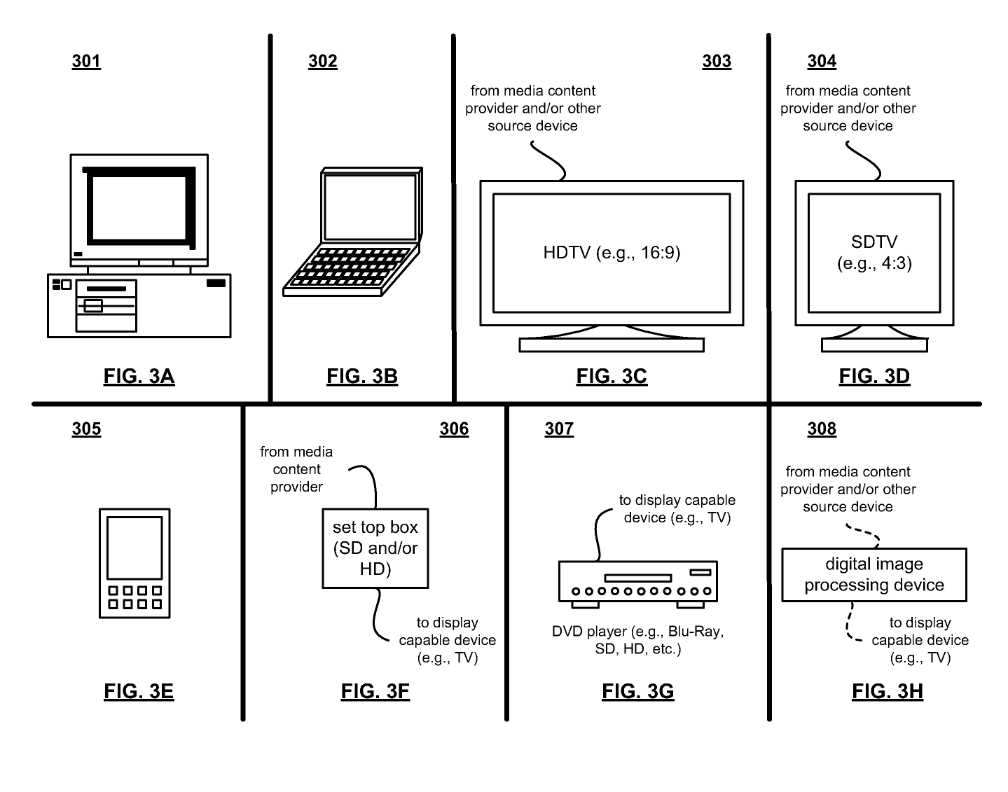

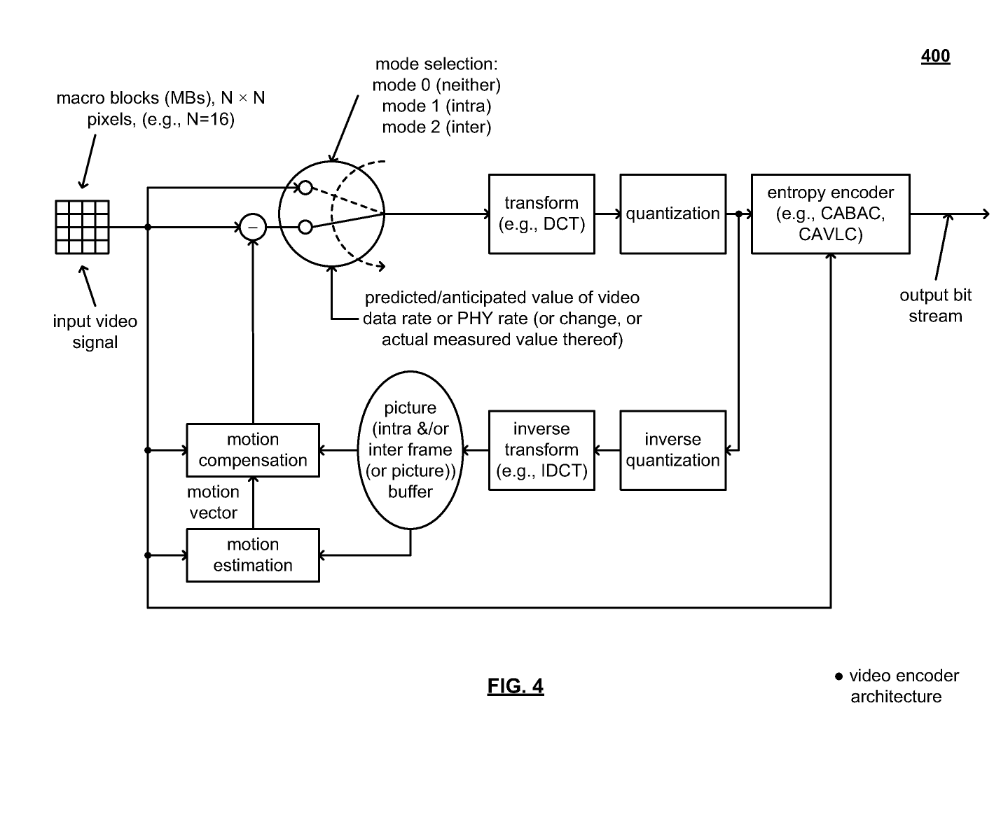

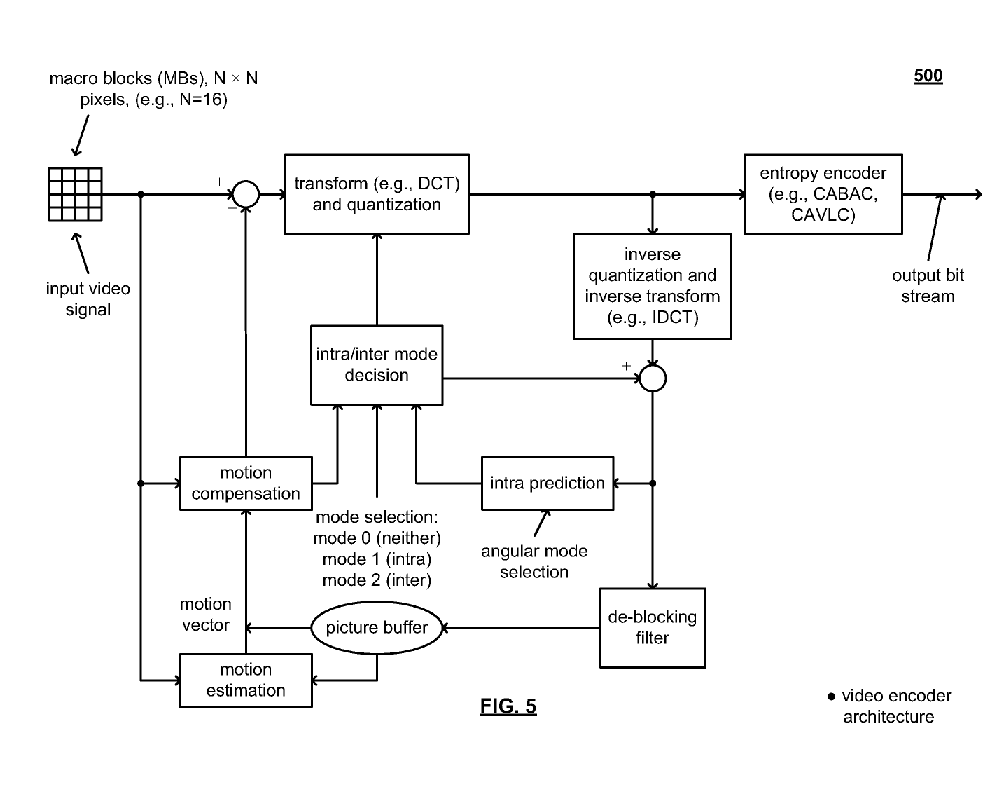

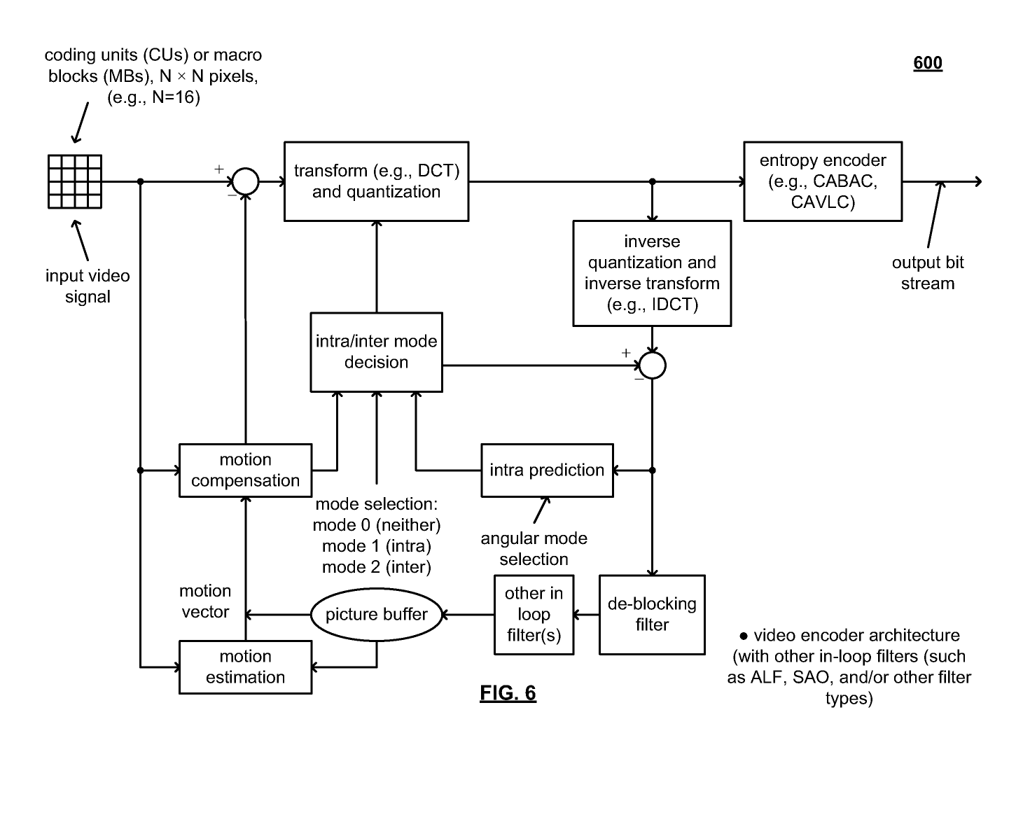

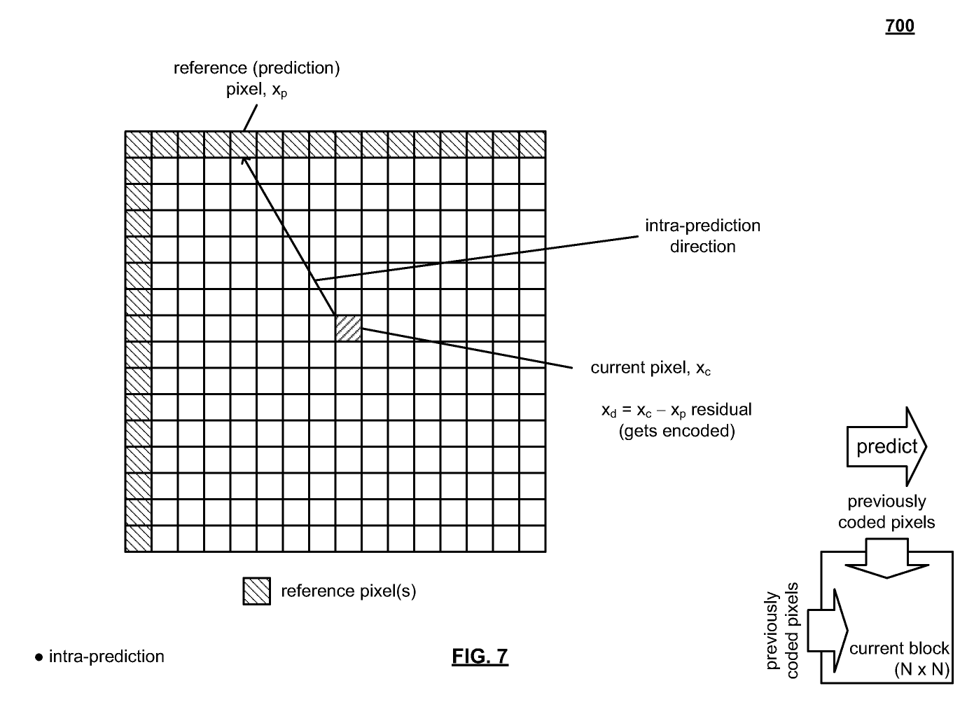

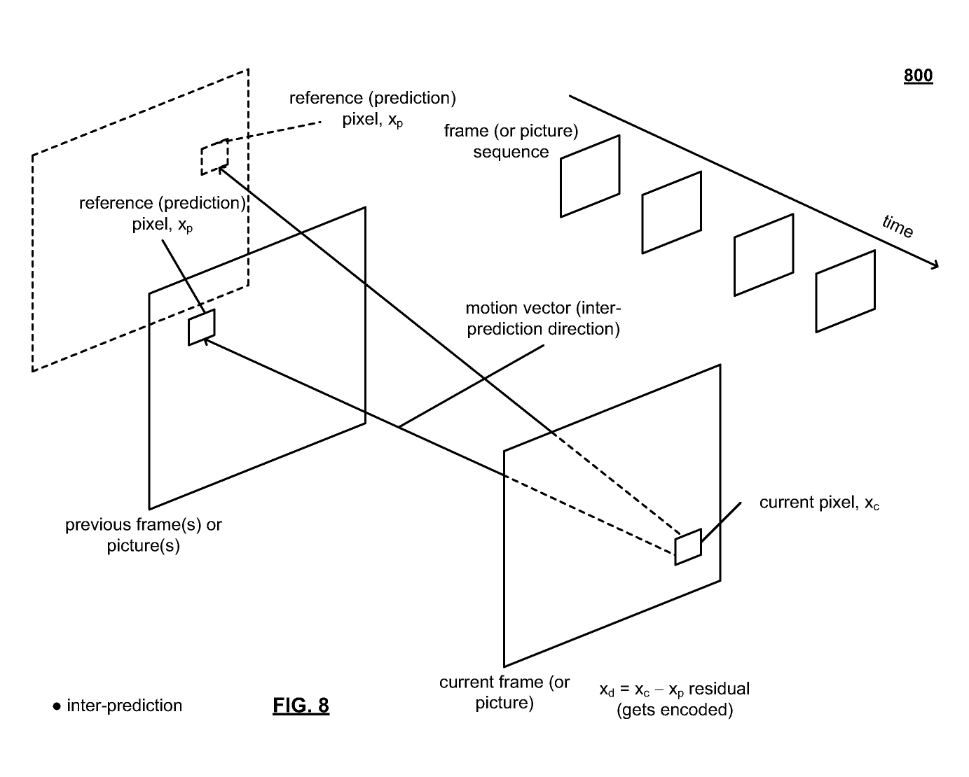

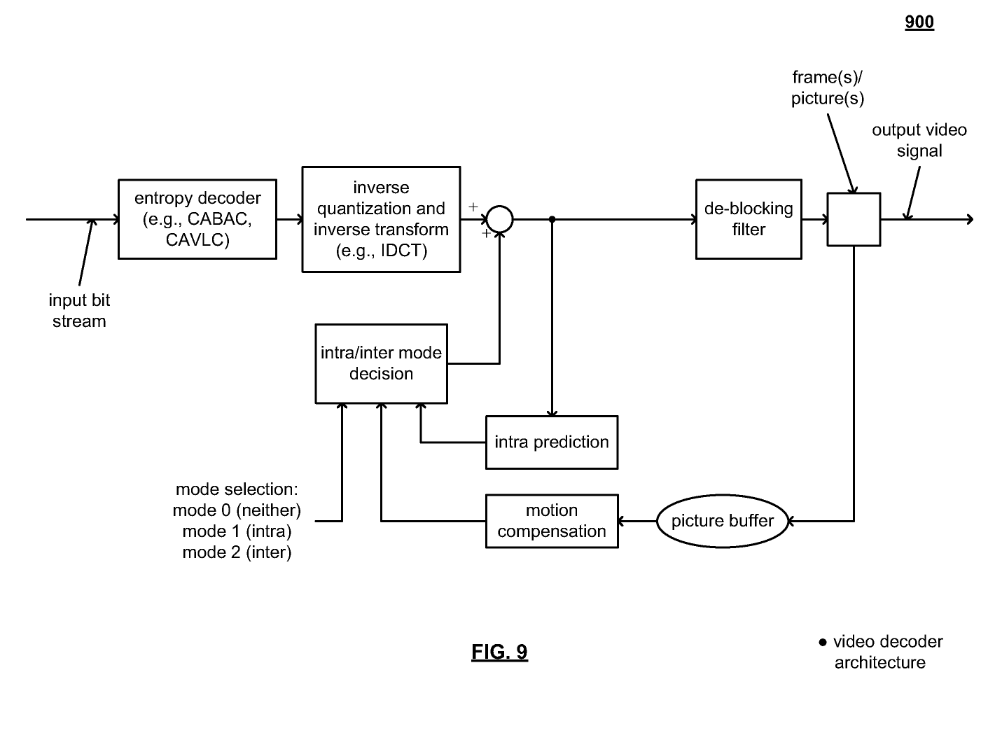

Digital image and/or video processing of digital images and/or media (including the respective images within a digital video signal) may be performed by any of the various devices depicted below in FIG. 3A-3H to allow a user to view such digital images and/or video. These various devices do not include an exhaustive list of devices in which the image and/or video processing described herein may be effectuated, and it is noted that any generic digital image and/or video processing device may be implemented to perform the processing described herein without departing from the scope and spirit of the invention.

FIG. 3A illustrates an embodiment of a computer 301. The computer 301 can be a desktop computer, or an enterprise storage devices such a server, of a host computer that is attached to a storage array such as a redundant array of independent disks (RAID) array, storage router, edge router, storage switch and/or storage director. A user is able to view still digital images and/or video (e.g., a sequence of digital images) using the computer 301. Oftentimes, various image and/or video viewing programs and/or media player programs are included on a computer 301 to allow a user to view such images (including video).

FIG. 3B illustrates an embodiment of a laptop computer 302. Such a laptop computer 302 may be found and used in any of a wide variety of contexts. In recent years, with the ever-increasing processing capability and functionality found within laptop computers, they are being employed in many instances where previously higher-end and more capable desktop computers would be used. As with the computer 301, the laptop computer 302 may include various image viewing programs and/or media player programs to allow a user to view such images (including video).

FIG. 3C illustrates an embodiment of a high definition (HD) television 303. Many HD televisions 303 include an integrated tuner to allow the receipt, processing, and decoding of media content (e.g., television broadcast signals) thereon. Alternatively, sometimes an HD television 303 receives media content from another source such as a digital video disc (DVD) player, set top box (STB) that receives, processes, and decodes a cable and/or satellite television broadcast signal. Regardless of the particular implementation, the HD television 303 may be implemented to perform image and/or video processing as described herein. Generally speaking, an HD television 303 has capability to display HD media content and oftentimes is implemented having a 16:9 widescreen aspect ratio.

FIG. 3D illustrates an embodiment of a standard definition (SD) television 304. Of course, an SD television 304 is somewhat analogous to an HD television 303, with at least one difference being that the SD television 304 does not include capability to display HD media content, and an SD television 304 oftentimes is implemented having a 4:3 full screen aspect ratio. Nonetheless, even an SD television 304 may be implemented to perform image and/or video processing as described herein.

FIG. 3E illustrates an embodiment of a handheld media unit 305. A handheld media unit 305 may operate to provide general storage or storage of image/video content information such as joint photographic experts group (JPEG) files, tagged image file format (TIFF), bitmap, motion picture experts group (MPEG) files, Windows Media (WMA/WMV) files, other types of video content such as MPEG4 files, etc. for playback to a user, and/or any other type of information that may be stored in a digital format. Historically, such handheld media units were primarily employed for storage and playback of audio media; however, such a handheld media unit 305 may be employed for storage and playback of virtual any media (e.g., audio media, video media, photographic media, etc.). Moreover, such a handheld media unit 305 may also include other functionality such as integrated communication circuitry for wired and wireless communications. Such a handheld media unit 305 may be implemented to perform image and/or video processing as described herein.

FIG. 3F illustrates an embodiment of a set top box (STB) 306. As mentioned above, sometimes a STB 306 may be implemented to receive, process, and decode a cable and/or satellite television broadcast signal to be provided to any appropriate display capable device such as SD television 304 and/or HD television 303. Such an STB 306 may operate independently or cooperatively with such a display capable device to perform image and/or video processing as described herein.

FIG. 3G illustrates an embodiment of a digital video disc (DVD) player 307. Such a DVD player may be a Blu-Ray DVD player, an HD capable DVD player, an SD capable DVD player, an up-sampling capable DVD player (e.g., from SD to HD, etc.) without departing from the scope and spirit of the invention. The DVD player may provide a signal to any appropriate display capable device such as SD television 304 and/or HD television 303. The DVD player 305 may be implemented to perform image and/or video processing as described herein.

FIG. 3H illustrates an embodiment of a generic digital image and/or video processing device 308. Again, as mentioned above, these various devices described above do not include an exhaustive list of devices in which the image and/or video processing described herein may be effectuated, and it is noted that any generic digital image and/or video processing device 308 may be implemented to perform the image and/or video processing described herein without departing from the scope and spirit of the invention.

FIG. 4, FIG. 5, and FIG. 6 are diagrams illustrating various embodiments 400 and 500, and 600, respectively, of video encoding architectures.

Referring to embodiment 400 of FIG. 4, as may be seen with respect to this diagram, an input video signal is received by a video encoder. In certain embodiments, the input video signal is composed of coding units (CUs) or macro-blocks (MBs). The size of such coding units or macro-blocks may be varied and can include a number of pixels typically arranged in a square shape. In one embodiment, such coding units or macro-blocks have a size of 16×16 pixels. However, it is generally noted that a macro-block may have any desired size such as N×N pixels, where N is an integer. Of course, some implementations may include non-square shaped coding units or macro-blocks, although square shaped coding units or macro-blocks are employed in a preferred embodiment.

The input video signal may generally be referred to as corresponding to raw frame (or picture) image data. For example, raw frame (or picture) image data may undergo processing to generate luma and chroma samples. In some embodiments, the set of luma samples in a macro-block is of one particular arrangement (e.g., 16×16), and set of the chroma samples is of a different particular arrangement (e.g., 8×8). In accordance with the embodiment depicted herein, a video encoder processes such samples on a block by block basis.

The input video signal then undergoes mode selection by which the input video signal selectively undergoes intra and/or inter-prediction processing. Generally speaking, the input video signal undergoes compression along a compression pathway. When operating with no feedback (e.g., in accordance with neither inter-prediction nor intra-prediction), the input video signal is provided via the compression pathway to undergo transform operations (e.g., in accordance with discrete cosine transform (DCT)). Of course, other transforms may be employed in alternative embodiments. In this mode of operation, the input video signal itself is that which is compressed. The compression pathway may take advantage of the lack of high frequency sensitivity of human eyes in performing the compression.

However, feedback may be employed along the compression pathway by selectively using inter- or intra-prediction video encoding. In accordance with a feedback or predictive mode of operation, the compression pathway operates on a (relatively low energy) residual (e.g., a difference) resulting from subtraction of a predicted value of a current macro-block from the current macro-block. Depending upon which form of prediction is employed in a given instance, a residual or difference between a current macro-block and a predicted value of that macro-block based on at least a portion of that same frame (or picture) or on at least a portion of at least one other frame (or picture) is generated.

The resulting modified video signal then undergoes transform operations along the compression pathway. In one embodiment, a discrete cosine transform (DCT) operates on a set of video samples (e.g., luma, chroma, residual, etc.) to compute respective coefficient values for each of a predetermined number of basis patterns. For example, one embodiment includes 64 basis functions (e.g., such as for an 8×8 sample). Generally speaking, different embodiments may employ different numbers of basis functions (e.g., different transforms). Any combination of those respective basis functions, including appropriate and selective weighting thereof, may be used to represent a given set of video samples. Additional details related to various ways of performing transform operations are described in the technical literature associated with video encoding including those standards/draft standards that have been incorporated by reference as indicated above. The output from the transform processing includes such respective coefficient values. This output is provided to a quantizer.

Generally, most image blocks will typically yield coefficients (e.g., DCT coefficients in an embodiment operating in accordance with discrete cosine transform (DCT)) such that the most relevant DCT coefficients are of lower frequencies. Because of this and of the human eyes' relatively poor sensitivity to high frequency visual effects, a quantizer may be operable to convert most of the less relevant coefficients to a value of zero. That is to say, those coefficients whose relative contribution is below some predetermined value (e.g., some threshold) may be eliminated in accordance with the quantization process. A quantizer may also be operable to convert the significant coefficients into values that can be coded more efficiently than those that result from the transform process. For example, the quantization process may operate by dividing each respective coefficient by an integer value and discarding any remainder. Such a process, when operating on typical coding units or macro-blocks, typically yields a relatively low number of non-zero coefficients which are then delivered to an entropy encoder for lossless encoding and for use in accordance with a feedback path which may select intra-prediction and/or inter-prediction processing in accordance with video encoding.

An entropy encoder operates in accordance with a lossless compression encoding process. In comparison, the quantization operations are generally lossy. The entropy encoding process operates on the coefficients provided from the quantization process. Those coefficients may represent various characteristics (e.g., luma, chroma, residual, etc.). Various types of encoding may be employed by an entropy encoder. For example, context-adaptive binary arithmetic coding (CABAC) and/or context-adaptive variable-length coding (CAVLC) may be performed by the entropy encoder. For example, in accordance with at least one part of an entropy coding scheme, the data is converted to a (run, level) pairing (e.g., data 14, 3, 0, 4, 0, 0, −3 would be converted to the respective (run, level) pairs of (0, 14), (0, 3), (1, 4), (2, −3)). In advance, a table may be prepared that assigns variable length codes for value pairs, such that relatively shorter length codes are assigned to relatively common value pairs, and relatively longer length codes are assigned for relatively less common value pairs.

As the reader will understand, the operations of inverse quantization and inverse transform correspond to those of quantization and transform, respectively. For example, in an embodiment in which a DCT is employed within the transform operations, then an inverse DCT (IDCT) is that employed within the inverse transform operations.

A picture buffer, alternatively referred to as a digital picture buffer or a DPB, receives the signal from the IDCT module; the picture buffer is operative to store the current frame (or picture) and/or one or more other frames (or pictures) such as may be used in accordance with intra-prediction and/or inter-prediction operations as may be performed in accordance with video encoding. It is noted that in accordance with intra-prediction, a relatively small amount of storage may be sufficient, in that, it may not be necessary to store the current frame (or picture) or any other frame (or picture) within the frame (or picture) sequence. Such stored information may be employed for performing motion compensation and/or motion estimation in the case of performing inter-prediction in accordance with video encoding.

In one possible embodiment, for motion estimation, a respective set of luma samples (e.g., 16×16) from a current frame (or picture) are compared to respective buffered counterparts in other frames (or pictures) within the frame (or picture) sequence (e.g., in accordance with inter-prediction). In one possible implementation, a closest matching area is located (e.g., prediction reference) and a vector offset (e.g., motion vector) is produced. In a single frame (or picture), a number of motion vectors may be found and not all will necessarily point in the same direction. One or more operations as performed in accordance with motion estimation are operative to generate one or more motion vectors.

Motion compensation is operative to employ one or more motion vectors as may be generated in accordance with motion estimation. A prediction reference set of samples is identified and delivered for subtraction from the original input video signal in an effort hopefully to yield a relatively (e.g., ideally, much) lower energy residual. If such operations do not result in a yielded lower energy residual, motion compensation need not necessarily be performed and the transform operations may merely operate on the original input video signal instead of on a residual (e.g., in accordance with an operational mode in which the input video signal is provided straight through to the transform operation, such that neither intra-prediction nor inter-prediction are performed), or intra-prediction may be utilized and transform operations performed on the residual resulting from intra-prediction. Also, if the motion estimation and/or motion compensation operations are successful, the motion vector may also be sent to the entropy encoder along with the corresponding residual's coefficients for use in undergoing lossless entropy encoding.

The output from the overall video encoding operation is an output bit stream. It is noted that such an output bit stream may of course undergo certain processing in accordance with generating a continuous time signal which may be transmitted via a communication channel. For example, certain embodiments operate within wireless communication systems. In such an instance, an output bitstream may undergo appropriate digital to analog conversion, frequency conversion, scaling, filtering, modulation, symbol mapping, and/or any other operations within a wireless communication device that operate to generate a continuous time signal capable of being transmitted via a communication channel, etc.

Referring to embodiment 500 of FIG. 5, as may be seen with respect to this diagram, an input video signal is received by a video encoder. In certain embodiments, the input video signal is composed of coding units or macro-blocks (and/or may be partitioned into coding units (CUs)). The size of such coding units or macro-blocks may be varied and can include a number of pixels typically arranged in a square shape. In one embodiment, such coding units or macro-blocks have a size of 16×16 pixels. However, it is generally noted that a macro-block may have any desired size such as N×N pixels, where N is an integer. Of course, some implementations may include non-square shaped coding units or macro-blocks, although square shaped coding units or macro-blocks are employed in a preferred embodiment.

The input video signal may generally be referred to as corresponding to raw frame (or picture) image data. For example, raw frame (or picture) image data may undergo processing to generate luma and chroma samples. In some embodiments, the set of luma samples in a macro-block is of one particular arrangement (e.g., 16×16), and set of the chroma samples is of a different particular arrangement (e.g., 8×8). In accordance with the embodiment depicted herein, a video encoder processes such samples on a block by block basis.

The input video signal then undergoes mode selection by which the input video signal selectively undergoes intra and/or inter-prediction processing. Generally speaking, the input video signal undergoes compression along a compression pathway. When operating with no feedback (e.g., in accordance with neither inter-prediction nor intra-prediction), the input video signal is provided via the compression pathway to undergo transform operations (e.g., in accordance with discrete cosine transform (DCT)). Of course, other transforms may be employed in alternative embodiments. In this mode of operation, the input video signal itself is that which is compressed. The compression pathway may take advantage of the lack of high frequency sensitivity of human eyes in performing the compression.

However, feedback may be employed along the compression pathway by selectively using inter- or intra-prediction video encoding. In accordance with a feedback or predictive mode of operation, the compression pathway operates on a (relatively low energy) residual (e.g., a difference) resulting from subtraction of a predicted value of a current macro-block from the current macro-block. Depending upon which form of prediction is employed in a given instance, a residual or difference between a current macro-block and a predicted value of that macro-block based on at least a portion of that same frame (or picture) or on at least a portion of at least one other frame (or picture) is generated.

The resulting modified video signal then undergoes transform operations along the compression pathway. In one embodiment, a discrete cosine transform (DCT) operates on a set of video samples (e.g., luma, chroma, residual, etc.) to compute respective coefficient values for each of a predetermined number of basis patterns. For example, one embodiment includes 64 basis functions (e.g., such as for an 8×8 sample). Generally speaking, different embodiments may employ different numbers of basis functions (e.g., different transforms). Any combination of those respective basis functions, including appropriate and selective weighting thereof, may be used to represent a given set of video samples. Additional details related to various ways of performing transform operations are described in the technical literature associated with video encoding including those standards/draft standards that have been incorporated by reference as indicated above. The output from the transform processing includes such respective coefficient values. This output is provided to a quantizer.

Generally, most image blocks will typically yield coefficients (e.g., DCT coefficients in an embodiment operating in accordance with discrete cosine transform (DCT)) such that the most relevant DCT coefficients are of lower frequencies. Because of this and of the human eyes' relatively poor sensitivity to high frequency visual effects, a quantizer may be operable to convert most of the less relevant coefficients to a value of zero. That is to say, those coefficients whose relative contribution is below some predetermined value (e.g., some threshold) may be eliminated in accordance with the quantization process. A quantizer may also be operable to convert the significant coefficients into values that can be coded more efficiently than those that result from the transform process. For example, the quantization process may operate by dividing each respective coefficient by an integer value and discarding any remainder. Such a process, when operating on typical coding units or macro-blocks, typically yields a relatively low number of non-zero coefficients which are then delivered to an entropy encoder for lossless encoding and for use in accordance with a feedback path which may select intra-prediction and/or inter-prediction processing in accordance with video encoding.

An entropy encoder operates in accordance with a lossless compression encoding process. In comparison, the quantization operations are generally lossy. The entropy encoding process operates on the coefficients provided from the quantization process. Those coefficients may represent various characteristics (e.g., luma, chroma, residual, etc.). Various types of encoding may be employed by an entropy encoder. For example, context-adaptive binary arithmetic coding (CABAC) and/or context-adaptive variable-length coding (CAVLC) may be performed by the entropy encoder. For example, in accordance with at least one part of an entropy coding scheme, the data is converted to a (run, level) pairing (e.g., data 14, 3, 0, 4, 0, 0, −3 would be converted to the respective (run, level) pairs of (0, 14), (0, 3), (1, 4), (2, −3)). In advance, a table may be prepared that assigns variable length codes for value pairs, such that relatively shorter length codes are assigned to relatively common value pairs, and relatively longer length codes are assigned for relatively less common value pairs.

As the reader will understand, the operations of inverse quantization and inverse transform correspond to those of quantization and transform, respectively. For example, in an embodiment in which a DCT is employed within the transform operations, then an inverse DCT (IDCT) is that employed within the inverse transform operations.

An adaptive loop filter (ALF) is implemented to process the output from the inverse transform block. Such an adaptive loop filter (ALF) is applied to the decoded picture before it is stored in a picture buffer (sometimes referred to as a DPB, digital picture buffer). The adaptive loop filter (ALF) is implemented to reduce coding noise of the decoded picture, and the filtering thereof may be selectively applied on a slice by slice basis, respectively, for luminance and chrominance whether or not the adaptive loop filter (ALF) is applied either at slice level or at block level. Two-dimensional 2-D finite impulse response (FIR) filtering may be used in application of the adaptive loop filter (ALF). The coefficients of the filters may be designed slice by slice at the encoder, and such information is then signaled to the decoder (e.g., signaled from a transmitter communication device including a video encoder [alternatively referred to as encoder] to a receiver communication device including a video decoder [alternatively referred to as decoder]).

One embodiment operates by generating the coefficients in accordance with Wiener filtering design. In addition, it may be applied on a block by block based at the encoder whether the filtering is performed and such a decision is then signaled to the decoder (e.g., signaled from a transmitter communication device including a video encoder [alternatively referred to as encoder] to a receiver communication device including a video decoder [alternatively referred to as decoder]) based on quadtree structure, where the block size is decided according to the rate-distortion optimization. It is noted that the implementation of using such 2-D filtering may introduce a degree of complexity in accordance with both encoding and decoding. For example, by using 2-D filtering in accordance and implementation of an adaptive loop filter (ALF), there may be some increasing complexity within encoder implemented within the transmitter communication device as well as within a decoder implemented within a receiver communication device.

In certain optional embodiments, the output from the de-blocking filter is provided to one or more other in-loop filters (e.g., implemented in accordance with adaptive loop filter (ALF), sample adaptive offset (SAO) filter, and/or any other filter type) implemented to process the output from the inverse transform block. For example, such an ALF is applied to the decoded picture before it is stored in a picture buffer (again, sometimes alternatively referred to as a DPB, digital picture buffer). Such an ALF is implemented to reduce coding noise of the decoded picture, and the filtering thereof may be selectively applied on a slice by slice basis, respectively, for luminance and chrominance whether or not such an ALF is applied either at slice level or at block level. Two-dimensional 2-D finite impulse response (FIR) filtering may be used in application of such an ALF. The coefficients of the filters may be designed slice by slice at the encoder, and such information is then signaled to the decoder (e.g., signaled from a transmitter communication device including a video encoder [alternatively referred to as encoder] to a receiver communication device including a video decoder [alternatively referred to as decoder]).

One embodiment is operative to generate the coefficients in accordance with Wiener filtering design. In addition, it may be applied on a block by block based at the encoder whether the filtering is performed and such a decision is then signaled to the decoder (e.g., signaled from a transmitter communication device including a video encoder [alternatively referred to as encoder] to a receiver communication device including a video decoder [alternatively referred to as decoder]) based on quadtree structure, where the block size is decided according to the rate-distortion optimization. It is noted that the implementation of using such 2-D filtering may introduce a degree of complexity in accordance with both encoding and decoding. For example, by using 2-D filtering in accordance and implementation of an ALF, there may be some increasing complexity within encoder implemented within the transmitter communication device as well as within a decoder implemented within a receiver communication device.

As mentioned with respect to other embodiments, the use of an ALF can provide any of a number of improvements in accordance with such video processing, including an improvement on the objective quality measure by the peak to signal noise ratio (PSNR) that comes from performing random quantization noise removal. In addition, the subjective quality of a subsequently encoded video signal may be achieved from illumination compensation, which may be introduced in accordance with performing offset processing and scaling processing (e.g., in accordance with applying a gain) in accordance with ALF processing.

With respect to one type of an in-loop filter, the use of an adaptive loop filter (ALF) can provide any of a number of improvements in accordance with such video processing, including an improvement on the objective quality measure by the peak to signal noise ratio (PSNR) that comes from performing random quantization noise removal. In addition, the subjective quality of a subsequently encoded video signal may be achieved from illumination compensation, which may be introduced in accordance with performing offset processing and scaling processing (e.g., in accordance with applying a gain) in accordance with adaptive loop filter (ALF) processing.

Receiving the signal output from the ALF is a picture buffer, alternatively referred to as a digital picture buffer or a DPB; the picture buffer is operative to store the current frame (or picture) and/or one or more other frames (or pictures) such as may be used in accordance with intra-prediction and/or inter-prediction operations as may be performed in accordance with video encoding. It is noted that in accordance with intra-prediction, a relatively small amount of storage may be sufficient, in that, it may not be necessary to store the current frame (or picture) or any other frame (or picture) within the frame (or picture) sequence. Such stored information may be employed for performing motion compensation and/or motion estimation in the case of performing inter-prediction in accordance with video encoding.

In one possible embodiment, for motion estimation, a respective set of luma samples (e.g., 16×16) from a current frame (or picture) are compared to respective buffered counterparts in other frames (or pictures) within the frame (or picture) sequence (e.g., in accordance with inter-prediction). In one possible implementation, a closest matching area is located (e.g., prediction reference) and a vector offset (e.g., motion vector) is produced. In a single frame (or picture), a number of motion vectors may be found and not all will necessarily point in the same direction. One or more operations as performed in accordance with motion estimation are operative to generate one or more motion vectors.

Motion compensation is operative to employ one or more motion vectors as may be generated in accordance with motion estimation. A prediction reference set of samples is identified and delivered for subtraction from the original input video signal in an effort hopefully to yield a relatively (e.g., ideally, much) lower energy residual. If such operations do not result in a yielded lower energy residual, motion compensation need not necessarily be performed and the transform operations may merely operate on the original input video signal instead of on a residual (e.g., in accordance with an operational mode in which the input video signal is provided straight through to the transform operation, such that neither intra-prediction nor inter-prediction are performed), or intra-prediction may be utilized and transform operations performed on the residual resulting from intra-prediction. Also, if the motion estimation and/or motion compensation operations are successful, the motion vector may also be sent to the entropy encoder along with the corresponding residual's coefficients for use in undergoing lossless entropy encoding.

The output from the overall video encoding operation is an output bit stream. It is noted that such an output bit stream may of course undergo certain processing in accordance with generating a continuous time signal which may be transmitted via a communication channel. For example, certain embodiments operate within wireless communication systems. In such an instance, an output bitstream may undergo appropriate digital to analog conversion, frequency conversion, scaling, filtering, modulation, symbol mapping, and/or any other operations within a wireless communication device that operate to generate a continuous time signal capable of being transmitted via a communication channel, etc.

Referring to embodiment 600 of FIG. 6, with respect to this diagram depicting an alternative embodiment of a video encoder, such a video encoder carries out prediction, transform, and encoding processes to produce a compressed output bit stream. Such a video encoder may operate in accordance with and be compliant with one or more video encoding protocols, standards, and/or recommended practices such as ISO/IEC 14496-10—MPEG-4 Part 10, AVC (Advanced Video Coding), alternatively referred to as H.264/MPEG-4 Part 10 or AVC (Advanced Video Coding), ITU H.264/MPEG4-AVC.

It is noted that a corresponding video decoder, such as located within a device at another end of a communication channel, is operative to perform the complementary processes of decoding, inverse transform, and reconstruction to produce a respective decoded video sequence that is (ideally) representative of the input video signal.

As may be seen with respect to this diagram, alternative arrangements and architectures may be employed for effectuating video encoding. Generally speaking, an encoder processes an input video signal (e.g., typically composed in units of coding units or macro-blocks, often times being square in shape and including N×N pixels therein). The video encoding determines a prediction of the current macro-block based on previously coded data. That previously coded data may come from the current frame (or picture) itself (e.g., such as in accordance with intra-prediction) or from one or more other frames (or pictures) that have already been coded (e.g., such as in accordance with inter-prediction). The video encoder subtracts the prediction of the current macro-block to form a residual.

Generally speaking, intra-prediction is operative to employ block sizes of one or more particular sizes (e.g., 16×16, 8×8, or 4×4) to predict a current macro-block from surrounding, previously coded pixels within the same frame (or picture). Generally speaking, inter-prediction is operative to employ a range of block sizes (e.g., 16×16 down to 4×4) to predict pixels in the current frame (or picture) from regions that are selected from within one or more previously coded frames (or pictures).

With respect to the transform and quantization operations, a block of residual samples may undergo transformation using a particular transform (e.g., 4×4 or 8×8). One possible embodiment of such a transform operates in accordance with discrete cosine transform (DCT). The transform operation outputs a group of coefficients such that each respective coefficient corresponds to a respective weighting value of one or more basis functions associated with a transform. After undergoing transformation, a block of transform coefficients is quantized (e.g., each respective coefficient may be divided by an integer value and any associated remainder may be discarded, or they may be multiplied by an integer value). The quantization process is generally inherently lossy, and it can reduce the precision of the transform coefficients according to a quantization parameter (QP). Typically, many of the coefficients associated with a given macro-block are zero, and only some nonzero coefficients remain. Generally, a relatively high QP setting is operative to result in a greater proportion of zero-valued coefficients and smaller magnitudes of non-zero coefficients, resulting in relatively high compression (e.g., relatively lower coded bit rate) at the expense of relatively poorly decoded image quality; a relatively low QP setting is operative to allow more nonzero coefficients to remain after quantization and larger magnitudes of non-zero coefficients, resulting in relatively lower compression (e.g., relatively higher coded bit rate) with relatively better decoded image quality.

The video encoding process produces a number of values that are encoded to form the compressed bit stream. Examples of such values include the quantized transform coefficients, information to be employed by a decoder to re-create the appropriate prediction, information regarding the structure of the compressed data and compression tools employed during encoding, information regarding a complete video sequence, etc. Such values and/or parameters (e.g., syntax elements) may undergo encoding within an entropy encoder operating in accordance with CABAC, CAVLC, or some other entropy coding scheme, to produce an output bit stream that may be stored, transmitted (e.g., after undergoing appropriate processing to generate a continuous time signal that comports with a communication channel), etc.

In an embodiment operating using a feedback path, the output of the transform and quantization undergoes inverse quantization and inverse transform. One or both of intra-prediction and inter-prediction may be performed in accordance with video encoding. Also, motion compensation and/or motion estimation may be performed in accordance with such video encoding.

The signal path output from the inverse quantization and inverse transform (e.g., IDCT) block, which is provided to the intra-prediction block, is also provided to a de-blocking filter. The output from the de-blocking filter is provided to one or more other in-loop filters (e.g., implemented in accordance with adaptive loop filter (ALF), sample adaptive offset (SAO) filter, and/or any other filter type) implemented to process the output from the inverse transform block. For example, in one possible embodiment, an ALF is applied to the decoded picture before it is stored in a picture buffer (again, sometimes alternatively referred to as a DPB, digital picture buffer). The ALF is implemented to reduce coding noise of the decoded picture, and the filtering thereof may be selectively applied on a slice by slice basis, respectively, for luminance and chrominance whether or not the ALF is applied either at slice level or at block level. Two-dimensional 2-D finite impulse response (FIR) filtering may be used in application of the ALF. The coefficients of the filters may be designed slice by slice at the encoder, and such information is then signaled to the decoder (e.g., signaled from a transmitter communication device including a video encoder [alternatively referred to as encoder] to a receiver communication device including a video decoder [alternatively referred to as decoder]).

One embodiment generated the coefficients in accordance with Wiener filtering design. In addition, it may be applied on a block by block based at the encoder whether the filtering is performed and such a decision is then signaled to the decoder (e.g., signaled from a transmitter communication device including a video encoder [alternatively referred to as encoder] to a receiver communication device including a video decoder [alternatively referred to as decoder]) based on quadtree structure, where the block size is decided according to the rate-distortion optimization. It is noted that the implementation of using such 2-D filtering may introduce a degree of complexity in accordance with both encoding and decoding. For example, by using 2-D filtering in accordance and implementation of an ALF, there may be some increasing complexity within encoder implemented within the transmitter communication device as well as within a decoder implemented within a receiver communication device.

As mentioned with respect to other embodiments, the use of an ALF can provide any of a number of improvements in accordance with such video processing, including an improvement on the objective quality measure by the peak to signal noise ratio (PSNR) that comes from performing random quantization noise removal. In addition, the subjective quality of a subsequently encoded video signal may be achieved from illumination compensation, which may be introduced in accordance with performing offset processing and scaling processing (e.g., in accordance with applying a gain) in accordance with ALF processing.

With respect to any video encoder architecture implemented to generate an output bitstream, it is noted that such architectures may be implemented within any of a variety of communication devices. The output bitstream may undergo additional processing including error correction code (ECC), forward error correction (FEC), etc. thereby generating a modified output bitstream having additional redundancy deal therein. Also, as may be understood with respect to such a digital signal, it may undergo any appropriate processing in accordance with generating a continuous time signal suitable for or appropriate for transmission via a communication channel That is to say, such a video encoder architecture may be implemented within a communication device operative to perform transmission of one or more signals via one or more communication channels. Additional processing may be made on an output bitstream generated by such a video encoder architecture thereby generating a continuous time signal that may be launched into a communication channel.

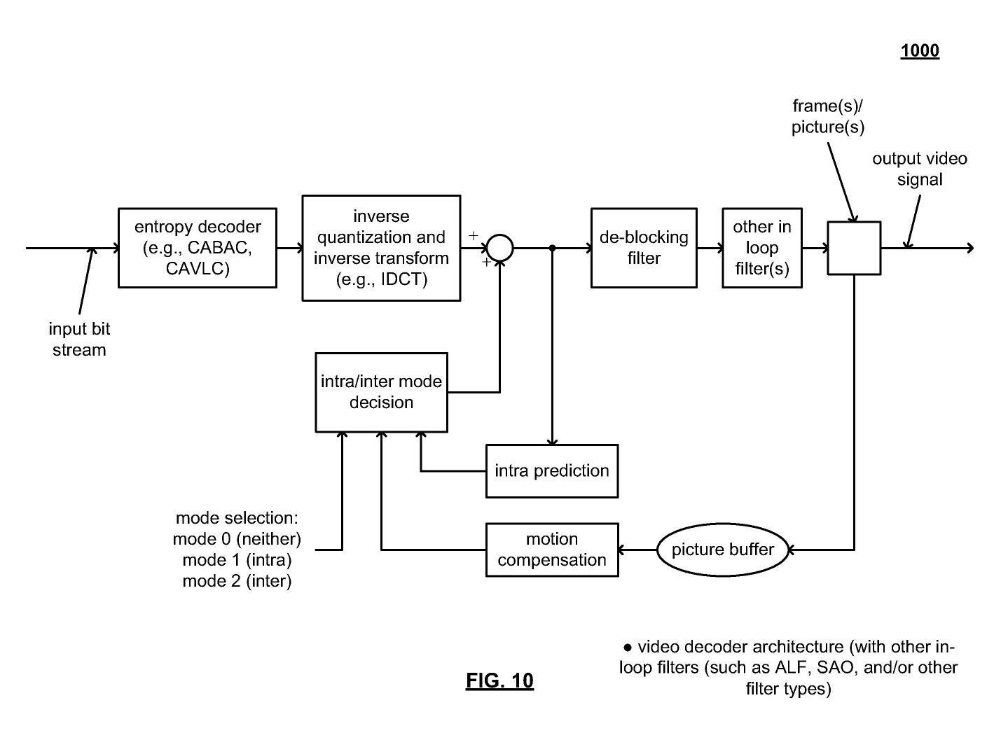

FIG. 7 is a diagram illustrating an embodiment 700 of intra-prediction processing. As can be seen with respect to this diagram, a current block of video data (e.g., often times being square in shape and including generally N×N pixels) undergoes processing to estimate the respective pixels therein. Previously coded pixels located above and to the left of the current block are employed in accordance with such intra-prediction. From certain perspectives, an intra-prediction direction may be viewed as corresponding to a vector extending from a current pixel to a reference pixel located above or to the left of the current pixel. Details of intra-prediction as applied to coding in accordance with H.264/AVC are specified within the corresponding standard (e.g., International Telecommunication Union, ITU-T, TELECOMMUNICATION STANDARDIZATION SECTOR OF ITU, H.264 (03/2010), SERIES H: AUDIOVISUAL AND MULTIMEDIA SYSTEMS, Infrastructure of audiovisual services—Coding of moving video, Advanced video coding for generic audiovisual services, Recommendation ITU-T H.264, also alternatively referred to as International Telecomm ISO/IEC 14496-10—MPEG-4 Part 10, AVC (Advanced Video Coding), H.264/MPEG-4 Part 10 or AVC (Advanced Video Coding), ITU H.264/MPEG4-AVC, or equivalent) that is incorporated by reference above.

The residual, which is the difference between the current pixel and the reference or prediction pixel, is that which gets encoded. As can be seen with respect to this diagram, intra-prediction operates using pixels within a common frame (or picture). It is of course noted that a given pixel may have different respective components associated therewith, and there may be different respective sets of samples for each respective component.

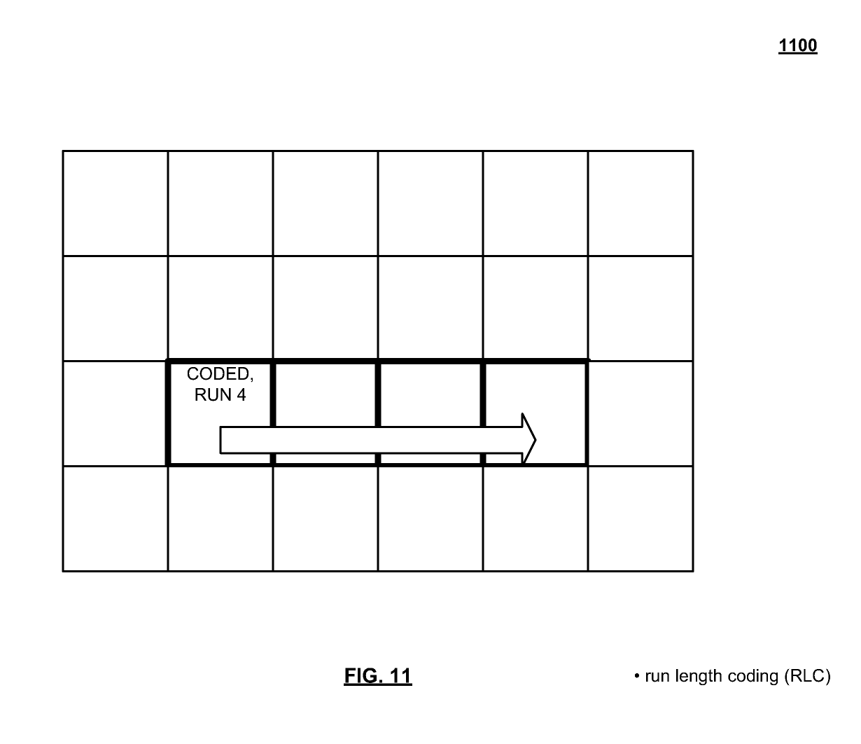

FIG. 8 is a diagram illustrating an embodiment 800 of inter-prediction processing. In contradistinction to intra-prediction, inter-prediction is operative to identify a motion vector (e.g., an inter-prediction direction) based on a current set of pixels within a current frame (or picture) and one or more sets of reference or prediction pixels located within one or more other frames (or pictures) within a frame (or picture) sequence. As can be seen, the motion vector extends from the current frame (or picture) to another frame (or picture) within the frame (or picture) sequence. Inter-prediction may utilize sub-pixel interpolation, such that a prediction pixel value corresponds to a function of a plurality of pixels in a reference frame or picture.

A residual may be calculated in accordance with inter-prediction processing, though such a residual is different from the residual calculated in accordance with intra-prediction processing. In accordance with inter-prediction processing, the residual at each pixel again corresponds to the difference between a current pixel and a predicted pixel value. However, in accordance with inter-prediction processing, the current pixel and the reference or prediction pixel are not located within the same frame (or picture). While this diagram shows inter-prediction as being employed with respect to one or more previous frames or pictures, it is also noted that alternative embodiments may operate using references corresponding to frames before and/or after a current frame. For example, in accordance with appropriate buffering and/or memory management, a number of frames may be stored. When operating on a given frame, references may be generated from other frames that precede and/or follow that given frame.

Coupled with the CU, a basic unit may be employed for the prediction partition mode, namely, the prediction unit, or PU. It is also noted that the PU is defined only for the last depth CU, and its respective size is limited to that of the CU.

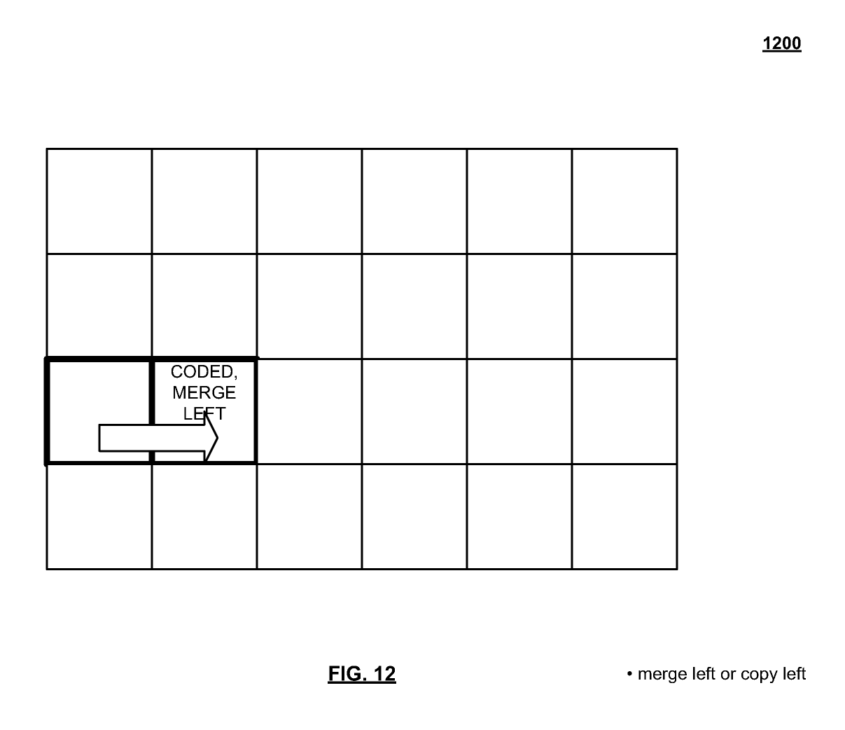

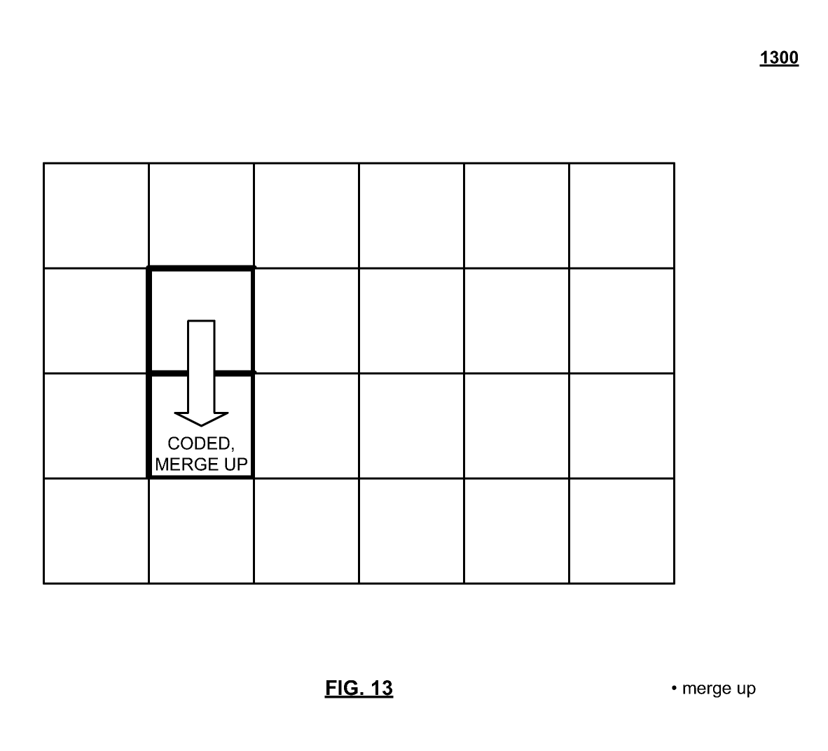

FIG. 9 and FIG. 10 are diagrams illustrating various embodiments 900 and 1000, respectively, of video decoding architectures.

Generally speaking, such video decoding architectures operate on an input bitstream. It is of course noted that such an input bitstream may be generated from a signal that is received by a communication device from a communication channel. Various operations may be performed on a continuous time signal received from the communication channel, including digital sampling, demodulation, scaling, filtering, etc. such as may be appropriate in accordance with generating the input bitstream. Moreover, certain embodiments, in which one or more types of error correction code (ECC), forward error correction (FEC), etc. may be implemented, may perform appropriate decoding in accordance with such ECC, FEC, etc. thereby generating the input bitstream. That is to say, in certain embodiments in which additional redundancy may have been made in accordance with generating a corresponding output bitstream (e.g., such as may be launched from a transmitter communication device or from the transmitter portion of a transceiver communication device), appropriate processing may be performed in accordance with generating the input bitstream. Overall, such a video decoding architectures and lamented to process the input bitstream thereby generating an output video signal corresponding to the original input video signal, as closely as possible and perfectly in an ideal case, for use in being output to one or more video display capable devices.

Referring to the embodiment 900 of FIG. 9, generally speaking, a decoder such as an entropy decoder (e.g., which may be implemented in accordance with CABAC, CAVLC, etc.) processes the input bitstream in accordance with performing the complementary process of encoding as performed within a video encoder architecture. The input bitstream may be viewed as being, as closely as possible and perfectly in an ideal case, the compressed output bitstream generated by a video encoder architecture. Of course, in a real-life application, it is possible that some errors may have been incurred in a signal transmitted via one or more communication links. The entropy decoder processes the input bitstream and extracts the appropriate coefficients, such as the DCT coefficients (e.g., such as representing chroma, luma, etc. information) and provides such coefficients to an inverse quantization and inverse transform block. In the event that a DCT transform is employed, the inverse quantization and inverse transform block may be implemented to perform an inverse DCT (IDCT) operation. Subsequently, A/D blocking filter is implemented to generate the respective frames and/or pictures corresponding to an output video signal. These frames and/or pictures may be provided into a picture buffer, or a digital picture buffer (DPB) for use in performing other operations including motion compensation. Generally speaking, such motion compensation operations may be viewed as corresponding to inter-prediction associated with video encoding. Also, intra-prediction may also be performed on the signal output from the inverse quantization and inverse transform block. Analogously as with respect to video encoding, such a video decoder architecture may be implemented to perform mode selection between performing it neither intra-prediction nor inter-prediction, inter-prediction, or intra-prediction in accordance with decoding an input bitstream thereby generating an output video signal.

Referring to the embodiment 1000 of FIG. 10, in certain optional embodiments, one or more in-loop filters (e.g., implemented in accordance with adaptive loop filter (ALF), sample adaptive offset (SAO) filter, and/or any other filter type) such as may be implemented in accordance with video encoding as employed to generate an output bitstream, a corresponding one or more in-loop filters may be implemented within a video decoder architecture. In one embodiment, an appropriate implementation of one or more such in-loop filters is after the de-blocking filter.

With respect to video coding, such as in accordance with HEVC (e.g., such as in accordance with its various proposals, developing standards, recommended practices, etc.), frame-based signaling of certain parameters may be performed. For example, certain information associated with various frames of a video signal may be signaled (e.g., such as from a transmitter or encoder device to a receiver or decoder device). Such frame-based signaling of certain parameters may also be employed with respect to any other desired video coding proposals, standards, developing standards, recommended practices, etc. (e.g., including the moving or motion picture experts group (MPEG), etc.).

Video coding includes several major coding tools: temporal motion compensated prediction, spatial prediction, transform, quantization and entropy coding. The coding gain mostly comes from temporal motion compensated prediction and spatial prediction. By utilizing the prediction, the redundancy existing in the original video signal is significantly reduced. An encoder has to convey the information such as block partition mode, motion vectors, reference frame indices, spatial prediction direction, quantization parameter and coefficients to the corresponding decoder. In HEVC, such information may also further include sample adaptive offset (SAO) and/or adaptive loop filtering (ALF) data.

To efficiently convey these pieces of information, the traditional method is context adaptive arithmetic coding. For example, context adaptive binary arithmetic coding (CABAC) has been used in both H.264/AVC and HEVC. Context adaptivity can take advantage of spatial correlation among the information. But there is still limitation caused by the block based signaling.

Frame-based signaling in video coding can improve the coding efficiency further. Since the signaling is at the frame or picture level, the spatial correlation/redundancy can be exploited in a larger scale compared to at the block level.

For example, frame-based signaling may be viewed as fitting well to the frame level information such as object segmentation map and loop filtering parameters (SAO, ALF, etc.).

If an object segmentation map of a picture is signaled at frame level, other information can be coded more efficiently. For example, in motion vector prediction, we can select motion vector predictors based on the segmentation map. If a neighboring motion vector belongs to a different object from the current motion vector, we will not put that neighboring motion vector into the prediction candidate list of the current motion vector. Likewise, if a neighbor block belongs to a different object from the current block, we will not put that neighboring block into the motion merge candidate list. This can significantly reduce the number of candidates and consequently reduce the signaling bits for the selected candidate index.

Starting with a picture composed of blocks, data is encoded in raster scan order. Each block may contain object index from the segmentation map, SAO offset data and ALF filter coefficient data. The following coding methods can be used to represent the information.

In accordance with performing video coding, a number of different operations may be made to code SAO offset data or ALF filter coefficient data to improve overall video encoding efficiency. Some examples of such coding relate to “run length coding (RLC)”, “merge left”, “merge up”, and “copy entire row”.

For example, considering a framework picture composed of a number of LCU's, data is encoded in a raster scan order. It is noted that pictures may also be created with tiles, such that data is encoded in raster scan order within a tile in the tiles are scanned in raster scan order, respectively. Processing operation with respect to tiles would be correspondingly in analogously performed.

However, it is noted that certain implementation issues may arise due to the way certain data may be structured. For example, particularly with respect to on-chip or off chip memory and/or memory bandwidth, a great deal of memory management issues may arise. For example, not only an increase in cost arising from increased size, real estate, etc. of memory that may need to be provisioned to effectuate appropriate buffering in memory management of at least certain types of data, indexing issues may also arise given the significant amount of information that would need to be stored to assist in recursive steps needed to process at least some data associated with a current largest coding unit (LCU). Any of a number of different types of data may be handled using such signaling or frame-based signaling. For example, data associated with SAO and/or ALF parameters are some possible types of data that may be handled in accordance with such signaling.

For example, with respect to video encoding, data is sent (e.g., from a transmitter device to receiver device) in a compressed format (e.g., such as in accordance with any of the various video encoder architectures described herein, their equivalents, etc.). However, in accordance with performing decoding processing, it is desirable to decode such data associated with certain parameters (e.g., SAO and/or ALF related data) at the start of a given frame and to store that information in an efficient matter so that it is available and ready when the appropriate LCU is to be decoded. That is to say, certain LCU's may undergo processing based upon such data associated with certain parameters (e.g., SAO and/or ALF related data) as related to one or more other LCU's. As such, appropriate coordination between such data associated with one or more other LCU's may be employed in the decoding of a current LCU. As may be understood, effective and efficient access to such information allows for effective decoding of such a video signal.

With respect to the data construction of the respective LCU's of a video signal, certain issues may arise with respect to having available in accessing such data associated with certain parameters (e.g., SAO and/or ALF related data) as related to one or more other LCU's. For example, as may be understood with respect to other embodiments and/or diagrams described herein, the “merge up” and “copy entire row” related operations may suffer deleteriously from excessive memory management needs and requirements in some situations.

FIG. 11 illustrates an embodiment 1100 of run length coding (RLC). With respect to such RLC, with a run of N number of LCU's (or blocks), there may be no respective need to code the next N−1 LCU's (or blocks) in some situations. For example, with respect to encoding certain types of data associated with these respective LCU's (e.g., SAO and/or ALF related data associated with these respective LCU's), the same data may be used for each of the respective following LCU's. With respect to this diagram, the three respective LCU's to the right of a given LCU may be handled using the same data associated therewith (e.g., SAO and/or ALF related data). In this as well as other diagrams, the arrow-based convention shows dependency with the tail of the arrow indicating source and the head of the arrow indicating sink. That is to say, the non-pointed end of the arrow indicates the source and the head/pointed end of the arrow shows the sink.

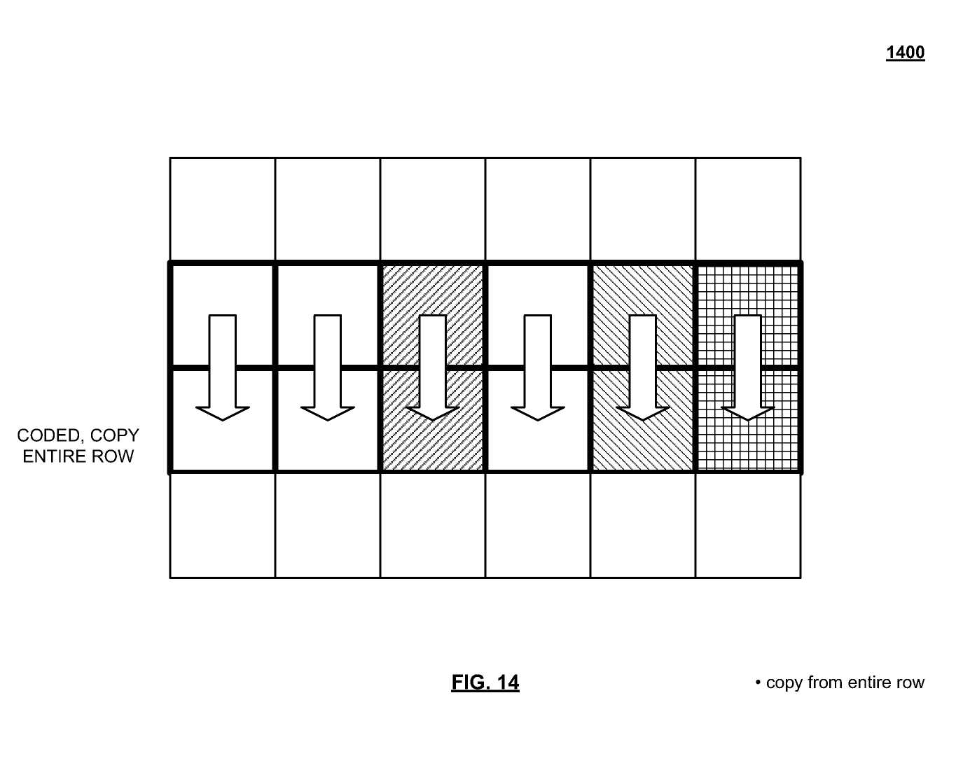

FIG. 12 illustrates an embodiment 1200 of merge left. With respect to this diagram, a given LCU uses data (e.g., SAO and/or ALF related data) associated with the LCU located to the left thereof.

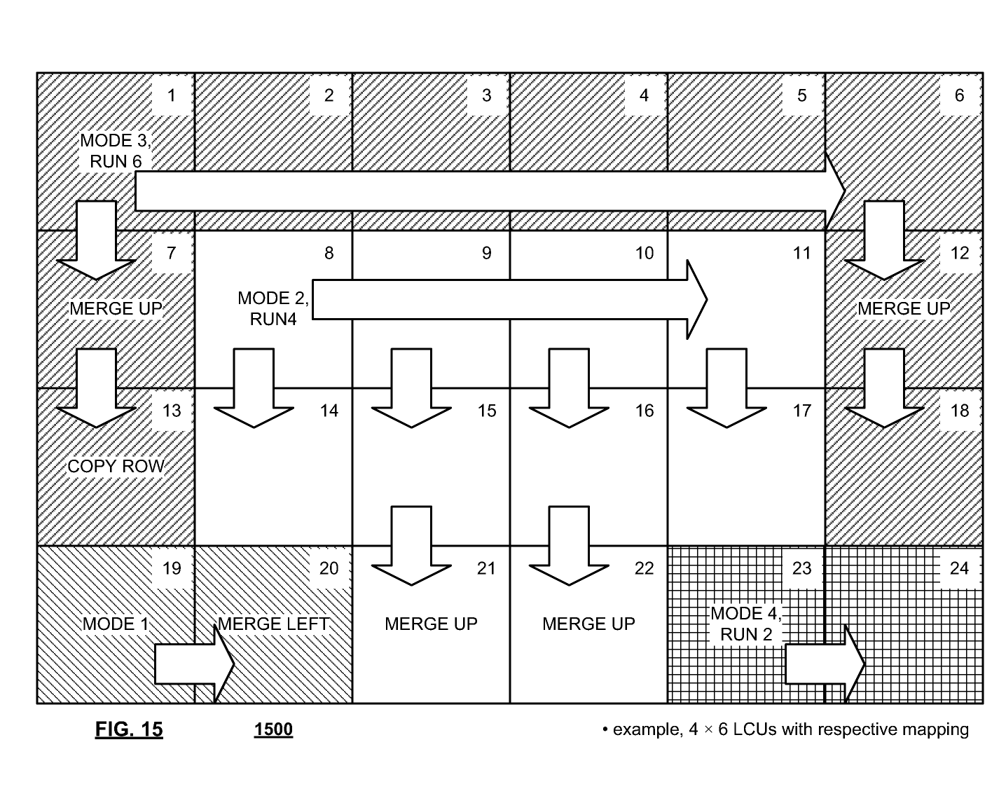

FIG. 13 illustrates an embodiment 1300 of merge up. With respect to this diagram, a given LCU uses data (e.g., SAO and/or ALF related data) associated with the LCU located above it.

FIG. 14 illustrates an embodiment 1400 of copy from entire row. With respect to this diagram, a number of respective LCU's within a given row respectively use data (e.g., SAO and/or ALF related data) associated with the corresponding and respective LCU's within a given row located above. As may be understood, the use of such data associated with those corresponding respective LCU's located within the given row located above is on a one-to-one basis, such that each respective LCU of the lower row uses the data associated with the respective LCU of the upper row (located above the lower row) on a one-to-one basis.

A number of different approaches to performing video encoding may be made. With respect to one embodiment (e.g., referred to as a brute force approach), determination would be made with respect to all possible modes by which processing may be performed, and this information could be stored in memory (e.g., a large table, a lookup table, etc. with one respective entry per LCU). As may be understood, such an exhaustive approach would be very costly in terms of memory requirements, indexing requirements, etc.

As may be understood with respect to this diagram, it may be desirable to decode all this data at start of frame and store in efficient manner to be ready when the appropriate block is to be decoded. But issues arise because of how data is constructed, particularly when using “copy from above” or “copy entire above row”. For example, frame level signaling includes the following information for a picture composed of 4×6 blocks.

FIG. 15 illustrates an embodiment 1500 of an example of a number of largest coding units (LCUs) with respective mapping there among. This particular diagram depicts 24 different respective LCU's and their respective relationship in terms of mapping. As may be seen, at least one type of data (e.g., SAO and/or ALF related data) associated with each respective LCU is related to at least one type of data associated with at least one other LCU. The respective mapping and relationship between the respective LCU's and the associated processing operations are depicted within the following diagram.

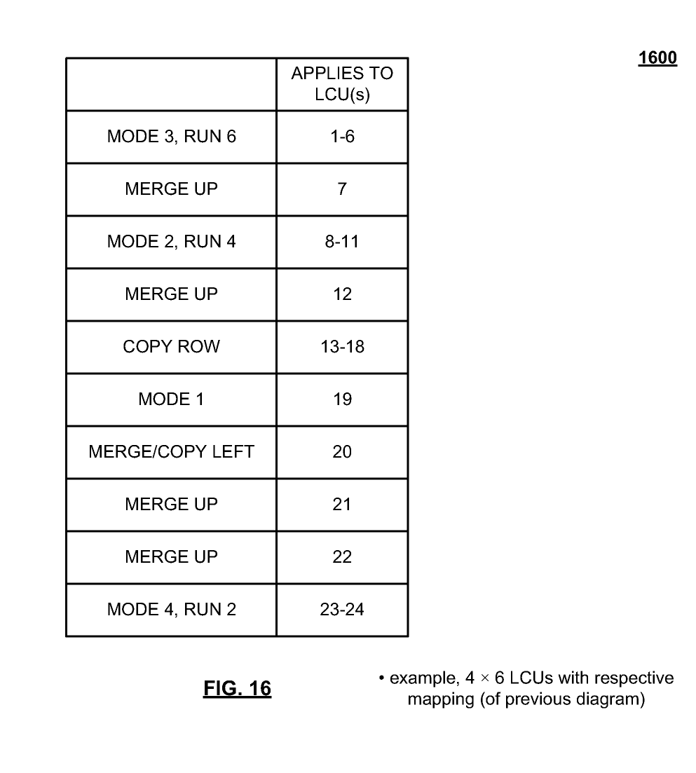

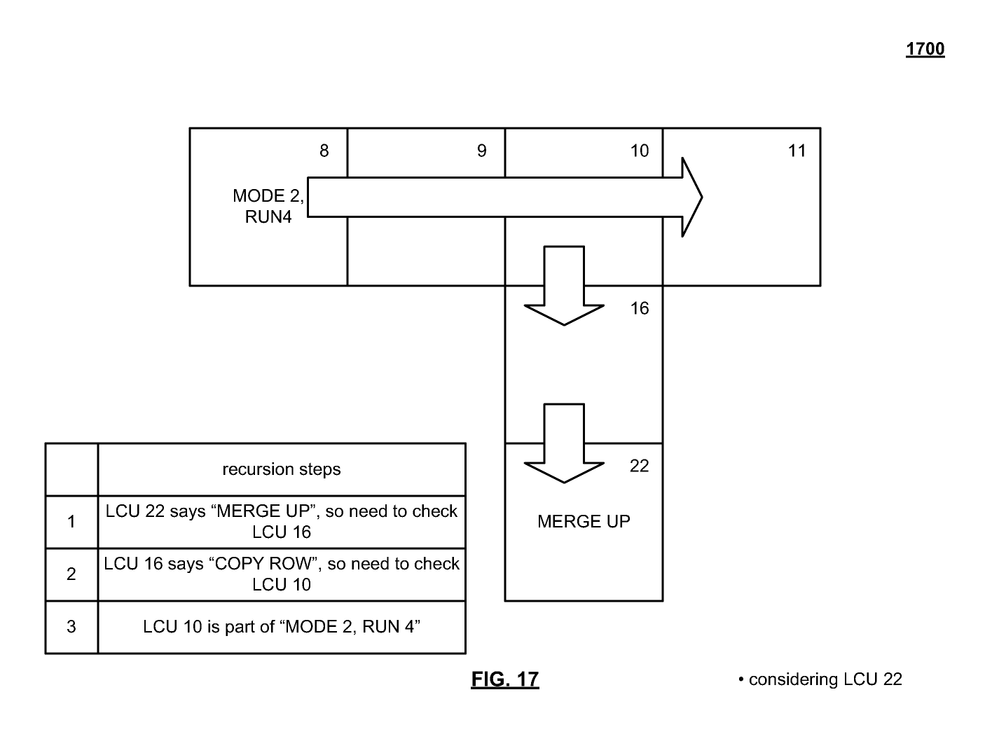

FIG. 16 illustrates an embodiment 1600 of the respective mapping associated with the LCUs depicted with respect to the previous diagram, FIG. 15. As may be understood with respect to FIG. 15 and FIG. 16, data with respect to this group of 4×6 LCU's (e.g., which may be viewed as being only a portion of a given frame or picture. With respect to this diagram, it is noted that the information included within the second column (applies to LCU(s)) is not transmitted (e.g., from a transmitter to a receiver), but is determined within the receiver (e.g., decoder) device.

Even considering this relatively small group of LCU's, it may be understood that keeping all of the data in original format may be very costly because of the relatively large amount of dependency between the respective LCU's. For example, a relatively significant number of processing steps, calculations, etc. may need to be performed to determine what respective mode is needed for any particular LCU.

Also, it may also not be convenient to keep data in original format because large amount of dependency would require lots of calculations to figure out what mode is needed for any particular block. As an example, for block 22 it says “MERGE UP” so we need to check block 16 and block 16 says “COPY ROW” so we need to check block 10 and block 10 is part of “MODE 2, RUN 4”. This example has three recursion steps but problem can be much worse when considering high resolution video.

On the other handle, a brute force method would be to figure out all the modes and store a big table or look-up table with one entry per block. This could be memory intensive.

Keep signaling in raw format and have a row buffer to store latest mode used. This limits recursion to at most one step. We still use block 22 as an example. Block 22 says “MERGE UP”, so we need to check block 16. Mode used in block 16 is in row buffer, so we can obtain directly.

As may be understood, in a receiver device (e.g., as including a decoder, such as a video decoder), tracking of the most recent used mode (and/or corresponding parameter(s)) may be performed. Such information may be stored in the referenced row buffer. Also, with respect to dependency among the various LCUs (or blocks), at most one step of recursion may exist between the various blocks (e.g., as opposed to among or along a string of multiple blocks). Also, as may be understood with respect to the various candidate lists used in accordance with such frame-based signaling, limitation or truncation of the number of elements that may be included therein (e.g., limitation is made of what may be used to generate such candidate lists).

FIG. 17 illustrates an embodiment 1700 of one of the respective LCUs of previous diagrams and recursion steps associated therewith. This diagram uses the LCU 22 for illustration. It may be difficult to determine a particular coding mode even if the appropriate position index is available. That is to say, there may be a number of respective steps through which the processing would have to retrace to determine what that respective mode should be.

Considering the LCU 22, there are at least three recursion steps which need to be performed to determine how to handle or determine at least one type of data (e.g., SAO and/or ALF related data) associated therewith. As may be seen with respect to this diagram as well as others (those respective LCU's specifically and directly related to LCU 22 are exacted from previous diagrams and shown in this diagram for ease of illustration to the reader), the LCU 22 is necessarily related to LCU 16 per the merge up operation associated therewith. Also, LCU 16 is necessarily related to LCU 10 per the operation associated therewith. LCU 10 is also necessarily related to and part of the RLC of which LCU's 8 through 11 are part (e.g., which also includes LCU 10). Even considering this example of the different respective recursion steps associated with LCU 22, it may be understood that three respective recursion steps are needed.

While three respective recursion steps when considering a relatively small group of LCU's (e.g., this group of 4×6 LCU's) may not necessarily be problematic, it may be understood that such recursion and interrelationship between different respective else use may be much worse and problematic when considering much larger groups of LCU's (e.g., high-resolution video). For example, considering a video signal (4k×2k) with LCU size of 16×16 would mean that there are 128 LCU rows. In accordance with such an implementation, it may be understood that there may be, in some cases (e.g., such as a relatively worse or worst-case scenario), potentially 128 respective steps of recursion associated therewith.

Considering the respective overall cost implemented in such an embodiment, and considering that such data associated with an LCU (e.g., SAO and/or ALF related data) costs K bytes, then using the brute force approach described above could be very memory intensive. For example, considering a frame or picture with M rows by N columns of LCU's, and if data would respectively be stored for every LCU, then the overall memory requirement would then be M×N×K. However, also considering using signaling in raw format, relatively significant recursion issues may arise as described above.

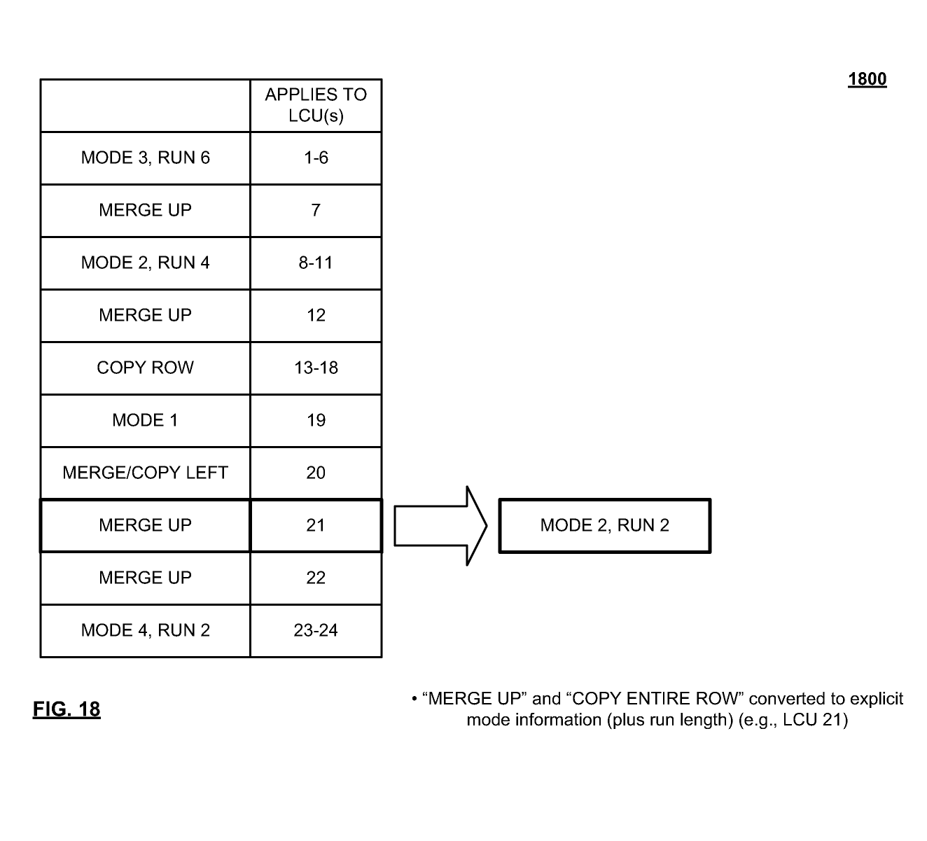

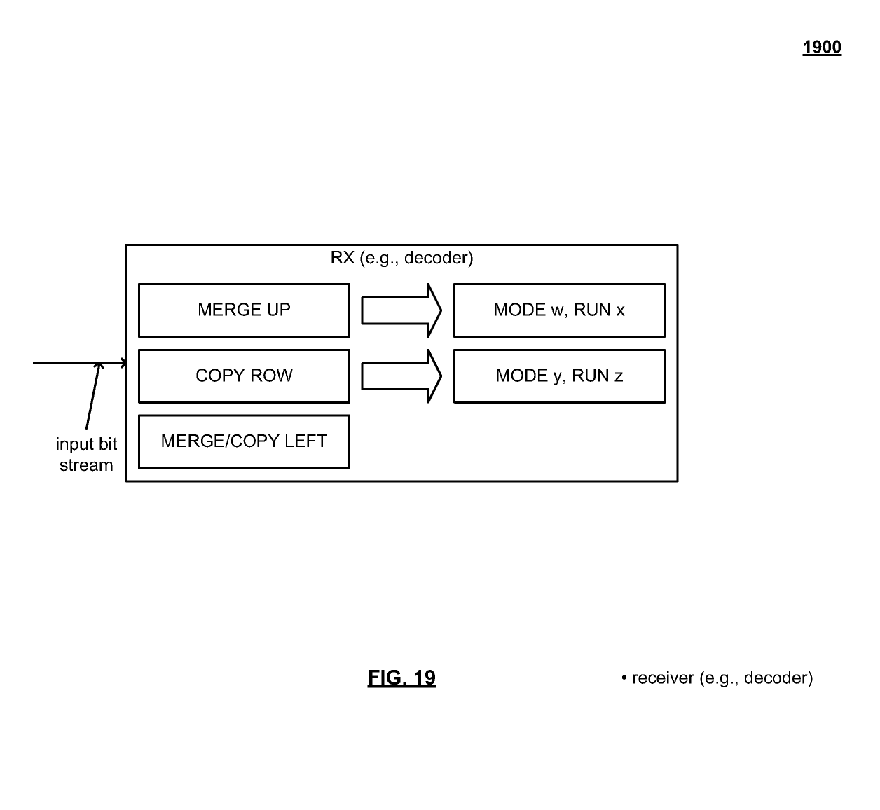

FIG. 18 illustrates an embodiment 1800 of selective conversion of some mappings to explicit mode information (plus run length). Certain data associated with an LCU (e.g., SAO and/or ALF related data) is decoded and stored for each respective role of LCU's as a particular mode (plus run length). For example, inter-row dependency (or inter-slice, inter-tile, etc. dependency) may be accommodated by converting the “merge up” and “copy entire row” operations to explicit mode information (plus run length). As may understood, the “merge left” or “copy left” operation need not be modified in may be left unchanged given that all of the information needed therefore is included in the same row (or slice, tile, etc.).

As may be seen, certain data associated with an LCU, if it is of a particular type or has a particular characteristic, is selectively converted to explicit mode information (plus run length). For example, if RLC is used, such coding does not cross a row (or slice, tile, etc.) boundary to simplify jumping in and decoding at an arbitrary row (or slice, tile, etc.). Which particular signal applies to any respective or particular LCU may be determined by a receiver device (e.g., decoder).

A particular row (or slice, tile, etc.) buffer may be implemented to store the latest mode used. For example, the memory size of such a row (or slice, tile, etc.) buffer would then be M×k as opposed to M×N×K.

Considering the processing associated with LCU 21, which currently or originally corresponds to “merge up” would then selectively be converted to explicit mode information (plus run length). For example, the operation associated therewith being “merge up” would selectively be converted to “MODE 2, RUN 2”. Other associated processing of “merge up” or “copy entire row” would also be converted correspondingly and appropriately to explicit mode information (plus run length).

The total memory required to effectuate such video decoding corresponds to the memory employed for signaling in raw format plus the memory associated with the mode row buffer. With no limits being placed on such signaling (e.g., in raw format), raw format related information could end up taking more and more memory. However, in a practical implementation, there may be certain limitations placed upon the maximum number of entries of signaling that may be allowed in raw format.

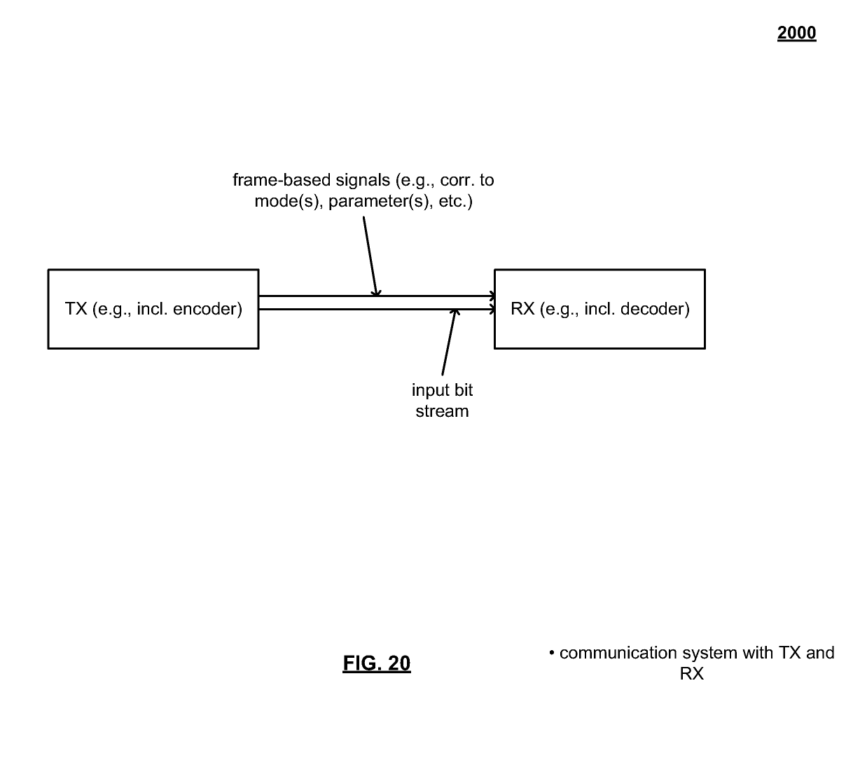

FIG. 19 illustrates an embodiment 1900 of a receiver device (e.g., a decoder). As may be seen with respect to this diagram, a given device such as a receiver (e.g., which could include a decoder therein) may be implemented to receive an input bitstream including her corresponding to video information. In addition, such a device could receive any one or more of a variety of frame-based signals corresponding to any one or more of a variety of parameters. For example, different respective LCU's of a framework picture of a video signal may have some interrelationship with respect to at least some types of data (e.g., SAO and/or ALF related data). Certain processing associated with these LCU's may be made such that one or more of the frame-based information signals corresponding to at least one of the various parameters is selectively converted or replaced with explicit mode information (plus run length). However, other certain processing associated with these LCU's may be maintained and unchanged. For example, processing associated with “merge up” or “copy entire row” may be selectively converted correspondingly and appropriately to explicit mode information (plus run length). However, the “merge left” or “copy left” operation may be maintained and unchanged.

As may be understood with respect to this diagram as well as with respect to other diagrams and/or embodiments herein, certain associated processing may be selectively converted to explicit mode information (plus run length) while other associated processing may be maintained and unchanged.

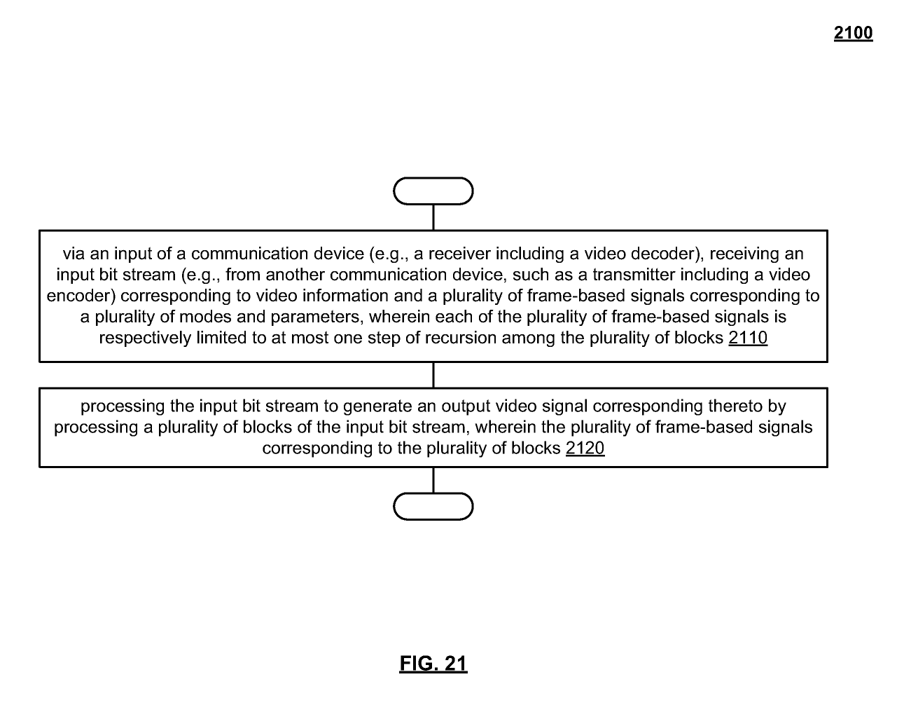

FIG. 20 illustrates an embodiment of a communication system with a transmitter (TX) and a receiver (RX). As may be understood with respect to various embodiments and/or diagrams herein, a significant reduction in the amount of signaling to be provided between devices may be achieved in accordance with various aspects, embodiments, and/or their equivalents, of the invention. For example, considering a communication system including at least two respective devices, namely, a transmitter device and a receiver device, the amount of signaling to be provided between those respective devices may be reduced significantly. Of course, either of these respective devices may be a transceiver device without departing from the scope and spirit of the invention. Considering such a transmitter device that includes an encoder, such as a video encoder, and a receiver device that includes a decoder, such as a video decoder, and output bitstream corresponding to an encoded video signal may be provided from the transmitter device and received by the receiver device. Such an output bitstream may be generated by a video encoder within the transmitter device and may subsequently undergo appropriate processing by a video decoder within the receiver device.

With respect to certain signaling that is provided between respective devices, such signaling may be performed in accordance with frame-based signaling. As may also be understood, a reduced size candidate list of various frame-based signaling information (e.g., prediction candidate list for use in calculating motion vectors, motion merge candidate list for use in processing a current block based upon one or more neighboring blocks, etc.) may be employed to reduce the signaling bits for any respective selected candidate index.

In at least one embodiment, a given receiver device may include an input to receive an input bit stream corresponding to video information and various frame-based signals corresponding to one or more modes and/or parameters. Also, such a receiver device may include a decoder to process the input bit stream to generate an output video signal corresponding thereto by processing a number of blocks of the input bit stream (e.g., such as the manner by which a given output bitstream generated by a video encoder or an input bitstream received by a video decoder may be partitioned into a number of respective blocks). It is noted that one or more frame-based signals may also be communicated from the transmitter device to the receiver device such that these one or more frame-based signals correspond respectively to the number of blocks. It is noted that any given singular frame-based signal may correspond to one or more respective blocks. Also, with respect to the recursion existence among the various blocks in the associated frame-based signaling, any respective frame-based signal is respectively limited to at most one step of recursion among the various blocks.

For example, in one embodiment, the various blocks may be viewed as having a corresponding arrangement in accordance with rows and columns, which may be understood with respect to a two-dimensional visualization and arrangement of the various blocks. With respect to the recursion among those various blocks, this described at most one step of recursion among the blocks may be understood as corresponding to a row dependency of one of the blocks to no more than one or more other blocks within a row adjacent to the block of interest. That is to say, with respect to processing and generating a given block, at most one step of recursion is required with respect that I give a block, and that particular step of recursion may be understood as corresponding to a row dependency of one of the blocks to no more than one or more other blocks within a row adjacent to the block of interest (i.e., that given block).

FIG. 21 illustrates an embodiment of a method performed by one or more devices. Referring to method 2100 of FIG. 21, via an input of a communication device (e.g., a receiver including a video decoder), the method 2100 begins by receiving an input bit stream (e.g., from another communication device, such as a transmitter including a video encoder) corresponding to video information and a plurality of frame-based signals corresponding to a plurality of modes and parameters, wherein each of the plurality of frame-based signals is respectively limited to at most one step of recursion among the plurality of blocks, as shown in a block 2110.

The method 2100 continues by processing the input bit stream to generate an output video signal corresponding thereto by processing a plurality of blocks of the input bit stream, wherein the plurality of frame-based signals corresponding to the plurality of blocks, as shown in a block 2120.

It is also noted that the various operations and functions as described with respect to various methods herein may be performed within a communication device, such as using a baseband processing module and/or a processing module implemented therein and/or other component(s) therein.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction with software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An apparatus, comprising:
an input to receive an input bit stream corresponding to video information and a plurality of frame-based signals corresponding to a plurality of modes and parameters; and
a decoder to process the input bit stream to generate an output video signal corresponding thereto by processing a plurality of blocks of the input bit stream; and
a row buffer to store at least one most recently used mode of at least a first of the plurality of blocks; and wherein:
the plurality of frame-based signals corresponding to the plurality of blocks;
the plurality of blocks having a corresponding arrangement to rows and columns;
each of the plurality of frame-based signals is respectively limited to at most one step of recursion among the plurality of blocks corresponding to a row dependency of any one of the plurality of blocks of the input bit stream to no more than one or more of the plurality of blocks in an adjacent row; and
the decoder to process at least a second of the plurality of blocks based on the at least one most recently used mode of the at least a first of the plurality of blocks.

2. The apparatus of claim 1, wherein the decoder selectively to:
replace at least one of the frame-based information signals corresponding to at least one of the plurality of modes and parameters with explicit mode information and associated run length; and
maintain at least one additional of the frame-based information signals corresponding to the at least one of the plurality of modes and parameters or maintain at least one additional of the plurality of modes and parameters unchanged.

3. The apparatus of claim 1, wherein the plurality of modes and parameters including:
run length coding (RLC) with a first number of blocks corresponding thereto;
merge left;
merge up; and
copy from entire row with a second number of blocks corresponding thereto.

4. The apparatus of claim 1, wherein:
the apparatus is a receiver or a transceiver communication device; and
the input bit stream corresponding to the video information and the plurality of frame-based signals received from a transmitter or at least one additional transceiver communication device; and
the plurality of frame-based signals received from the transmitter or the at least one additional transceiver communication device in raw format.

5. The apparatus of claim 1, wherein:
the apparatus being a communication device operative within at least one of a satellite communication system, a wireless communication system, a wired communication system, a fiber-optic communication system, and a mobile communication system.

6. An apparatus, comprising:
an input to receive an input bit stream corresponding to video information and a plurality of frame-based signals corresponding to a plurality of modes and parameters; and
a decoder to process the input bit stream to generate an output video signal corresponding thereto by processing a plurality of blocks of the input bit stream; and wherein:
the plurality of frame-based signals corresponding to the plurality of blocks; and
each of the plurality of frame-based signals is respectively limited to at most one step of recursion among the plurality of blocks.

7. The apparatus of claim 6, wherein:
the plurality of blocks having a corresponding arrangement to rows and columns; and
the at most one step of recursion among the plurality of blocks corresponding to a row dependency of any one of the plurality of blocks of the input bit stream to no more than one or more of the plurality of blocks in an adjacent row.

8. The apparatus of claim 6, wherein the decoder selectively to:
replace at least one of the frame-based information signals corresponding to at least one of the plurality of modes and parameters with explicit mode information and associated run length; and
maintain at least one additional of the frame-based information signals corresponding to the at least one of the plurality of modes and parameters or maintain at least one additional of the plurality of modes and parameters unchanged.

9. The apparatus of claim 6, further comprising:
a row buffer to store at least one most recently used mode of at least a first of the plurality of blocks; and wherein:
the decoder to process at least a second of the plurality of blocks based on the at least one most recently used mode of the at least a first of the plurality of blocks.

10. The apparatus of claim 6, wherein the plurality of modes and parameters including:
run length coding (RLC) with a first number of blocks corresponding thereto;
merge left;
merge up; and
copy from entire row with a second number of blocks corresponding thereto.

11. The apparatus of claim 6, wherein:
in accordance with generating a frame of the output video signal having an associated subset of the plurality of frame-based signals and an associated subset of the plurality of blocks, the decoder to decode and store the associated subset of the plurality of frame-based signals before processing the associated subset of the plurality of blocks.

12. The apparatus of claim 6, wherein:
the apparatus is a receiver or a transceiver communication device; and
the input bit stream corresponding to the video information and the plurality of frame-based signals received from a transmitter or at least one additional transceiver communication device; and
the plurality of frame-based signals received from the transmitter or the at least one additional transceiver communication device in raw format.

13. The apparatus of claim 6, wherein:
the apparatus being a communication device operative within at least one of a satellite communication system, a wireless communication system, a wired communication system, a fiber-optic communication system, and a mobile communication system.

14. A method for operating a communication device, the method comprising:
via an input of the communication device, receiving an input bit stream corresponding to video information and a plurality of frame-based signals corresponding to a plurality of modes and parameters, wherein each of the plurality of frame-based signals is respectively limited to at most one step of recursion among the plurality of blocks; and
processing the input bit stream to generate an output video signal corresponding thereto by processing a plurality of blocks of the input bit stream, wherein the plurality of frame-based signals corresponding to the plurality of blocks.

15. The method of claim 14, wherein:
the plurality of blocks having a corresponding arrangement to rows and columns; and
the at most one step of recursion among the plurality of blocks corresponding to a row dependency of any one of the plurality of blocks of the input bit stream to no more than one or more of the plurality of blocks in an adjacent row.

16. The method of claim 14, further comprising:
selectively replacing at least one of the frame-based information signals corresponding to at least one of the plurality of modes and parameters with explicit mode information and associated run length; and
selectively maintaining at least one additional of the frame-based information signals corresponding to the at least one of the plurality of modes and parameters or maintaining at least one additional of the plurality of modes and parameters unchanged.

17. The method of claim 14, further comprising:
employing a row buffer to store at least one most recently used mode of at least a first of the plurality of blocks; and
processing at least a second of the plurality of blocks based on the at least one most recently used mode of the at least a first of the plurality of blocks.

18. The method of claim 14, wherein the plurality of modes and parameters including:
run length coding (RLC) with a first number of blocks corresponding thereto;
merge left;
merge up; and
copy from entire row with a second number of blocks corresponding thereto.

19. The method of claim 14, further comprising:
in accordance with generating a frame of the output video signal having an associated subset of the plurality of frame-based signals and an associated subset of the plurality of blocks, decoding and storing the associated subset of the plurality of frame-based signals before processing the associated subset of the plurality of blocks.

20. The method of claim 14, wherein:
the communication device operative within at least one of a satellite communication system, a wireless communication system, a wired communication system, a fiber-optic communication system, and a mobile communication system.
